(19) United States
(12) Patent Application Publication
(10) Pub. No.: US 2026/0275193 A1
(43) Pub. Date: Sep. 17, 2026

(54) LIQUID CRYSTAL COMPOSITION AND USE THEREOF

(71) Applicant: Shijiazhuang Chengzhi Yonghua Display Material Co.,Ltd., Shijiazhuang (CN)

(72) Inventors: Yunxia QIAO, Shijiazhuang (CN); Yan WANG, Shijiazhuang (CN); Chang JU, Shijiazhuang (CN); Manfei REN, Shijiazhuang (CN); Xinxia WANG, Shijiazhuang (CN); Xiaolong WANG, Shijiazhuang (CN); Yazhuo WANG, Shijiazhuang (CN)

(21) Appl. No.: 19/157,974

(22) PCT Filed: Oct. 16, 2023
(86) PCT No.: PCT/CN2023/124697

§ 371 Date: Aug. 19, 2025

(30) Foreign Application Priority Data
Aug. 21, 2023 (CN) 202311051135.6

(51) Int. Cl. C09K 19/34; C09K 19/04; C09K 19/12; C09K 19/30; G02F 1/1362

(52) U.S. Cl. CPC C09K 19/3405; C09K 19/04; C09K 19/12; C09K 19/3003; G02F 1/1362; C09K 2019/0466; C09K 2019/122; C09K 2019/123; C09K 2019/3004; C09K 2019/301; C09K 2019/3408; C09K 2019/3422

(57) ABSTRACT

A liquid crystal composition includes one or more compounds represented by Formula I and one or more compounds represented by Formula II and/or Formula III. The liquid crystal composition has excellent flicker level and a relatively large elastic constant K₁₁ and a relatively small rotational viscosity γ₁ while maintaining a suitable optical anisotropy and a suitable clear point, that is, the liquid crystal composition has a relatively small γ₁/K₁₁ ratio, so that the liquid crystal display element and the liquid crystal display have a relatively fast response speed.

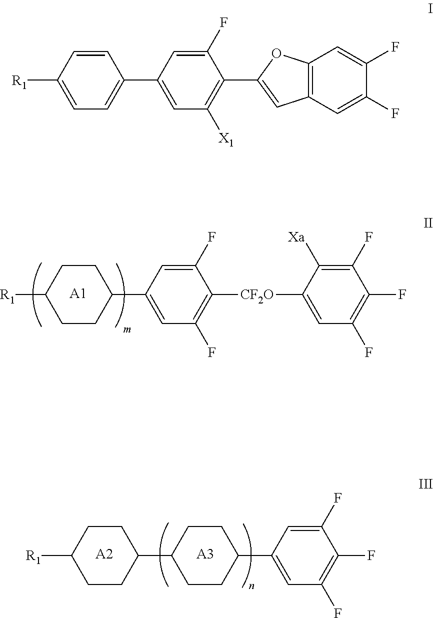

### TECHNICAL FIELD

The present invention relates to the technical field of liquid crystal display, in particular to a liquid crystal composition and a liquid crystal display element or display thereof.

### BACKGROUND ART

A liquid crystal material is a mixture of organic rod-like small molecular compounds with both liquid fluidity and crystal anisotropy at a certain temperature. Liquid crystal materials are widely used in smart watches, smart phones, tablet computers, computer monitors, televisions, data projectors, augmented reality (AR) and virtual reality (VR) displays due to the characteristics of optical anisotropy and dielectric anisotropy. Unlike traditional displays, AR and VR provide immersive interaction between human and digital information and are widely believed as the next generation of head-mounted displays.

In the past two decades, emerging technologies such as advanced liquid crystal materials and ultra-thin liquid crystal functional devices have greatly reshaped AR/VR display systems, making this breakthrough display platform truly integrated into the daily lives of people. Meanwhile, near-eye display and liquid crystal devices complement each other and promote the emergence of many impressive new liquid crystal devices supporting AR/VR. VR display creates a fully digital and truly immersive virtual environment for users. In contrast, AR display pursues high-quality see-through performance and enriches the real world by overlaying digital information. With these refreshing visual experiences, AR/VR displays have demonstrated extensive appeal and tremendous application potential.

Virtual reality (VR) is a technology that uses a special device to enable humans to interact with a generated digital environment, and head-mounted display devices are the optimal carriers for implementing VR technology. The head-mounted display (HMD) device can use optical lenses to magnify and display graphics and images output by the display within a field of view that is comfortable for human eyes. It is a wearable near-eye display device that can provide visual graphics and images for users without occupying the hands of users. HMD devices have the characteristics of modularity, customizable display, ingenuity, light weight, and no need for handheld operation. They can be used either as independent display devices or in combination with peripheral devices such as radar, gyroscopes, and night vision goggles. Since their inception, they have attracted significant attention and been widely used for simulation training, especially for ground simulation training in the fields of aviation, aerospace, etc. Theoretically, in medical scenes, doctors can view 3D medical imaging in VR and make diagnosis and preoperative planning. However, VR head-mounted display devices still have obvious artifacts during motion, which may reduce the quality of 3D images, thus affecting the accuracy of the visualization content, or even possibly affecting the reliability of medical diagnosis. Reducing the luminous duty cycle (operating cycle) of a display screen to 20% or less will help reduce motion blurring in VR head-mounted display devices. In addition, a low refresh rate of an input image will easily result in ghosting, thus affecting the image quality during motion. In addition to artifacts, when individual pixels of a VR image are magnified, a noticeable screen-door effect can still be observed. To alleviate the screen-door effect, some VR manufacturers have begun to use Fast-Switch LCD screens to improve the fineness of image quality.

In addition to high spatial resolution, the response speed of VR head-mounted display devices is also important, and increasing the refresh rate of the screen helps alleviate the problems of flickering, motion blurring, jitter, ghosting, etc. Currently, mainstream VR head-mounted display devices typically can reach 60 Hz or more. The refresh rate generally refers to a parameter of a display/screen. The typical refresh rates of display screens of most televisions, PCs, and smart phones are 60 Hz. For example, where a display is 60 Hz, it means that the physical refresh rate of a display/screen can reach at most 60 frames per second, that is, its upper limit is 60 Hz, which means that the display is refreshed 60 times per second, in other words, the image on the display is refreshed every 16.67 ms. Similarly, a refresh rate of 90 Hz means refreshing 90 times per second, and a refresh rate of 120 Hz means refreshing 120 times per second. Therefore, the refresh times of 90 Hz and 120 Hz display screens are 11.11 milliseconds and 8.33 milliseconds, respectively, which are relatively short. The time during which a single frame or image occupies the display screen is called the refresh time, and the refresh time is always inversely proportional to the refresh rate.

In addition to the VR/AR field, with the increasingly rapid development of science and technology, the requirements for display technology are continuously increasing, and the display industry is also constantly advancing, leading to also growing applications and requirements for liquid crystal display elements. People pursue smoother display frames on displays, and therefore, the requirements for higher screen refresh frequencies continue to rise.

When we are using smart phones, the display screen thereof is always in a working state. Whenever a new frame needs to be displayed, each pixel on the display screen must be refreshed, and the refreshing process proceeds from top to bottom, with each row of pixels refreshed simultaneously. When all the pixels have been refreshed from top to bottom, it means that the display screen has completed one refresh cycle. Therefore, the refresh rate of the display screen refers to the frequency at which the display screen is refreshed or updated. In the case of facing a computer screen and doing nothing, the display screen still continuously updates the images on the screen at a frequency of 60 times per second. Due to the persistence of vision of the human eyes, this change cannot be perceived, that is, the impression of the previous frame has not yet disappeared from the brain when the next frame follows immediately, and the spacing therebetween is only a 16.67 millisecond (1000/60≈16.67), creating an illusion of a static image on the screen. If the refresh frequency is changed to once per second, the image on the screen will flicker severely, which may easily cause symptoms such as eye fatigue, soreness, and dizziness. However, smart phones with higher refresh rates must bear an additional burden of bringing more pixels per second. Although we cannot clearly see individual refresh frames from 60 Hz to 90 Hz, 120 Hz, and even 144 Hz, we can perceive a continuous flow of frames on the display screen of the smart phone. In animation, when playing the same animation, a display screen with a refresh rate of 90 Hz has 1.5 times more frames as compared to a display screen with a refresh rate of 60 Hz. These additional frames make the motion in the entire animation smoother. While higher refresh rates offer many significant benefits for UI fluidity, the higher refresh rates have increased power consumption, which is a significant drawback. Compared with 60 Hz, when the display refresh rate is set to 90 Hz, the phone consumes more power because more frames need to be rendered for each animation, requiring additional work. Naturally, the refresh rates of 120 Hz and 144 Hz will result in even faster battery consumption.

Considering the power consumption issues caused by high refresh rates, many smart phone manufacturers offer a “Variable Refresh Rate” (VRR) mode in their customized Android systems. Generally, the “Variable Mode” changes the refresh rate of the display between set values based on applications, brightness, battery level, or other factors. For example, on a screen that supports a refresh rate of 90 Hz, the system automatically switches between 60 Hz and 90 Hz. This automatic switching mode can ensure that the battery will not be consumed too quickly while a good user experience is ensured. However, during the implementation of “Variable Mode”, screen tearing may occur (screen tearing refers to a situation where a new frame is output before the previous frame has completely disappeared, so the user sees two different frames simultaneously on the screen). Therefore, it is necessary to reach a lower flicker value by means of a liquid crystal, resulting in smaller flexural deformation, thereby realizing a better “Variable Refresh Rate” mode.

Therefore, developing a liquid crystal medium having both fast response and relatively fast refresh frequency is currently an urgent technical challenge to be solved.

### SUMMARY OF THE INVENTION

In view of this, the present invention provides a liquid crystal composition and a liquid crystal display element or display thereof. In the liquid crystal composition of the present invention, the synergistic effect of the compounds represented by Formula I and Formula II and/or Formula III is beneficial for the conduction and release of free radicals and ions in the liquid crystal composition, thereby improving the image retention level of the liquid crystal composition and finally improving the flicker issue of a liquid crystal display panel. In addition, due to the collocation of molecules in the liquid crystal composition, the liquid crystal molecules in the composition are less affected by an electric field, the deformation effect of the liquid crystal molecules is small, and the flexoelectric performance is excellent, finally improving the flicker level of the liquid crystal display panel and finding its use for satisfying the demand of broadband applications. In addition, the liquid crystal composition of the present invention has relatively large elastic constant K₁₁ and relatively small rotational viscosity γ₁ while maintaining suitable optical anisotropy and suitable clear point, that is, the liquid crystal composition of the present invention has a relatively small γ₁/K₁₁ ratio, so that the liquid crystal display element and the liquid crystal display have a relatively fast response speed.

In order to achieve the object of the present invention, the following technical solution is used in the present invention:

The present invention provides a liquid crystal composition. Preferably, the liquid crystal composition comprises one or more compounds represented by Formula I and one or more compounds represented by Formula II and/or Formula III,

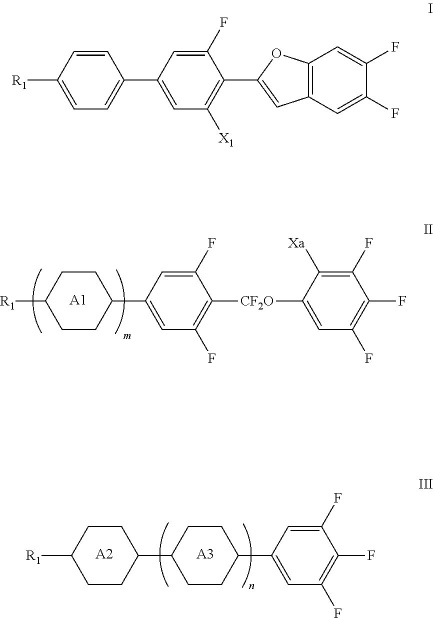

wherein R₁, R₂, and R₃ each independently represent alkyl with a carbon atom number of 1-15 or alkenyl with a carbon atom number of 2-15; and one or more non-adjacent —CH₂- in R₁ and R₂ are optionally substituted with cyclopentylene or cyclopropylene;
X₁ represents —H or —F; Xa represents —H or —CH₃;

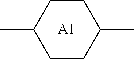

represents

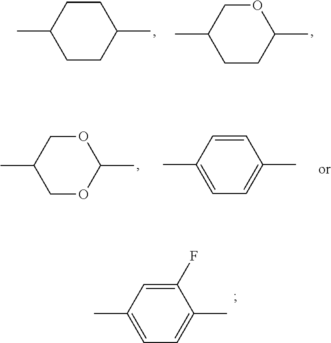

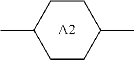

represents

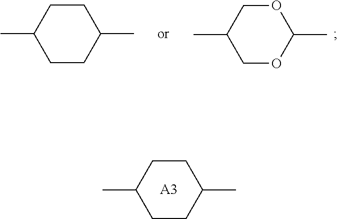

represents

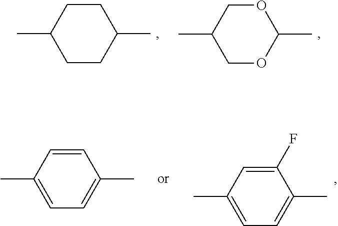

wherein

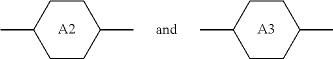

do not both represent

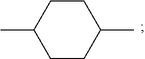

m and n each independently represent 1 or 2; and when m represents 2, two

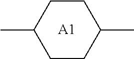

are optionally the same or different; and
when n represents 2, two

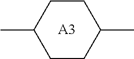

are optionally the same or different, and two

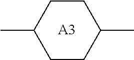

do not both represent

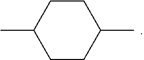

A second aspect of the present invention provides a liquid crystal composition. The liquid crystal composition comprises the above liquid crystal compound.

A third aspect of the present invention provides a liquid crystal display element or liquid crystal display. The liquid crystal display element or liquid crystal display comprises the above liquid crystal compound and liquid crystal composition.

### Beneficial Effects of the Invention

In the liquid crystal composition of the present invention, the synergistic effect of the compounds represented by Formula I and Formula II and/or Formula III is beneficial for the conduction and release of free radicals and ions in the liquid crystal composition, thereby improving the image retention level of the liquid crystal composition and finally improving the flicker issue of a liquid crystal display panel. In addition, due to the collocation of molecules in the liquid crystal composition, the liquid crystal molecules in the composition are less affected by an electric field, the deformation effect of the liquid crystal molecules is small, and the flexoelectric performance is excellent, finally improving the flicker level of the liquid crystal display panel and finding its use for satisfying the demand of broadband applications. In addition, the liquid crystal composition of the present invention has relatively large elastic constant K₁₁ and relatively small rotational viscosity γ₁ while maintaining suitable optical anisotropy and suitable clear point, that is, the liquid crystal composition of the present invention has a relatively small γ₁/K₁₁ ratio, so that the liquid crystal display element and the liquid crystal display have a relatively fast response speed.

### DETAILED DESCRIPTION OF EMBODIMENTS

The present invention provides a liquid crystal composition. Preferably, the liquid crystal composition comprises one or more compounds represented by Formula I and one or more compounds represented by Formula II and/or Formula III,

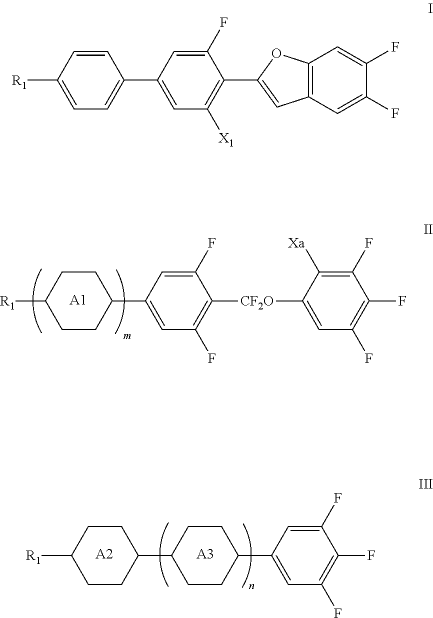

wherein R₁, R₂, and R₃ each independently represent alkyl with a carbon atom number of 1-15 or alkenyl with a carbon atom number of 2-15; and one or more non-adjacent —CH₂- in R₁ and R₂ are optionally substituted with cyclopentylene or cyclopropylene;
X₁ represents —H or —F; Xa represents —H or —CH₃;

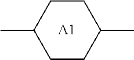

represents

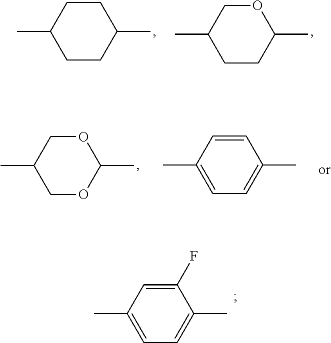

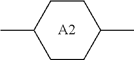

represents

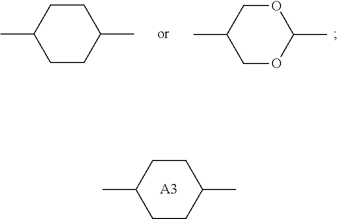

represents

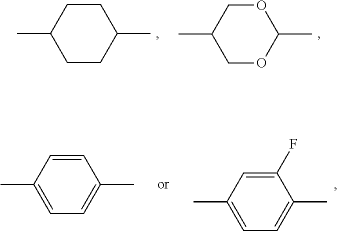

wherein

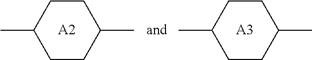

do not both represent

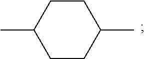

m and n each independently represent 1 or 2; and when m represents 2, two

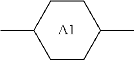

are optionally the same or different; and
when n represents 2, two

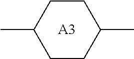

are optionally the same or different, and two

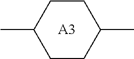

do not both represent

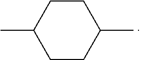

In the liquid crystal composition of the present invention, preferably, the above compound represented by Formula I is selected from the group consisting of compounds represented by the following Formulas I-1 and I-2,

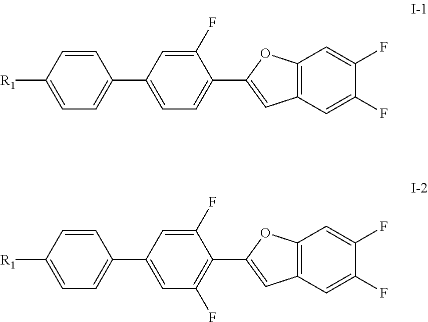

wherein R₁ represents alkyl with a carbon atom number of 1-15 or alkenyl with a carbon atom number of 2-15; and one or more non-adjacent —CH₂- in R₁ are optionally substituted with cyclopentylene or cyclopropylene.

In the liquid crystal composition of the present invention, preferably, the above compound represented by Formula I-1 is selected from the group consisting of compounds represented by the following Formulas I-1-1 to I-1-13,

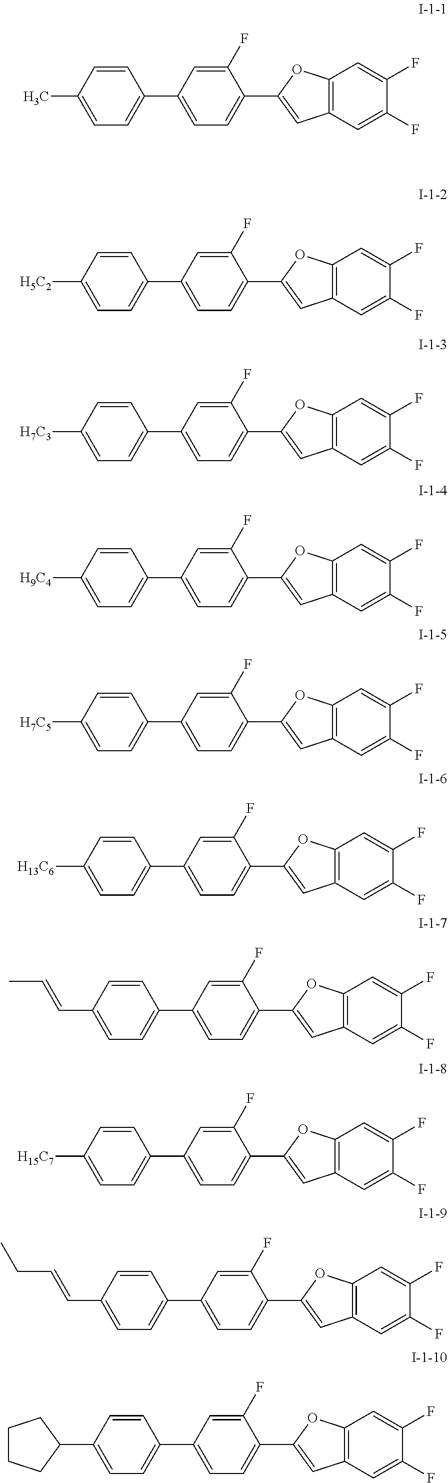

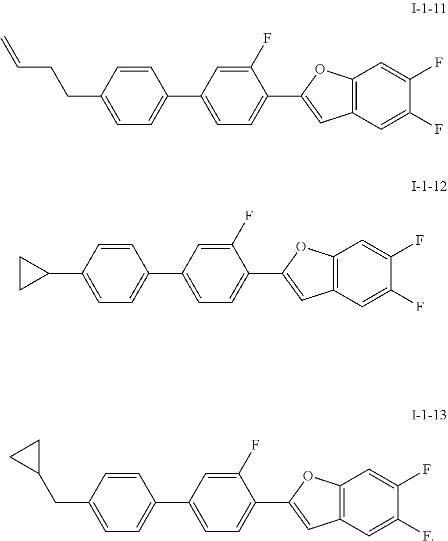 [SMILES: C=CCCc1ccc(-c2ccc(-c3cc4cc(F)c(F)cc4o3)c(F)c2)cc1 ; Fc1cc2cc(-c3ccc(-c4ccc(C5CC5)cc4)cc3F)oc2cc1F ; Fc1cc2cc(-c3ccc(-c4ccc(CC5CC5)cc4)cc3F)oc2cc1F]

In the liquid crystal composition of the present invention, preferably, the mass content of the above compound represented by Formula I-1 is 0.5-40%; further preferably, the above compound represented by Formula I-1 is selected from the group consisting of compounds represented by Formulas I-1-1, I-1-2, I-1-3, I-1-4, I-1-5, and I-1-9; and further more preferably, the content of each of the above compounds represented by Formulas I-1-1, I-1-2, I-1-3, I-1-4, I-1-5, and I-1-9 is 0.5-10%.

In the liquid crystal composition of the present invention, preferably, the above compound represented by Formula I-2 is selected from the group consisting of compounds represented by the following Formulas I-2-1 to I-2-8,

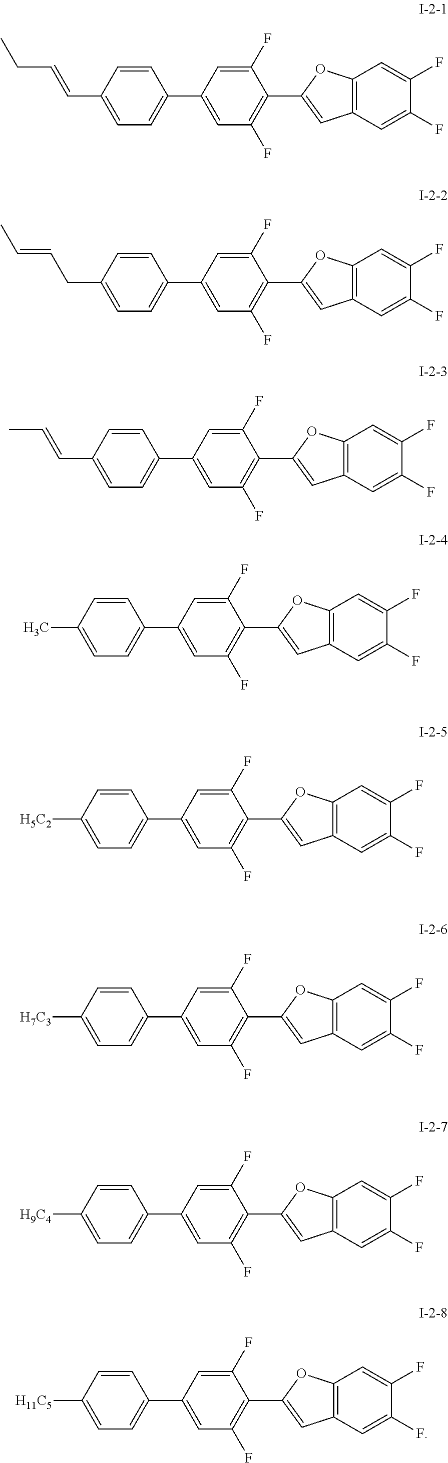

In the liquid crystal composition of the present invention, preferably, the above compound represented by Formula I-2 includes at least one of compounds represented by Formula I-2-5 and I-2-6; and further more preferably, the content of each of the above compounds represented by Formulas I-2-5 and I-2-6 is 0.5-10%.

In the liquid crystal composition of the present invention, preferably, the above compound represented by Formula II is selected from the group consisting of compounds represented by the following Formulas II-1 to II-7,

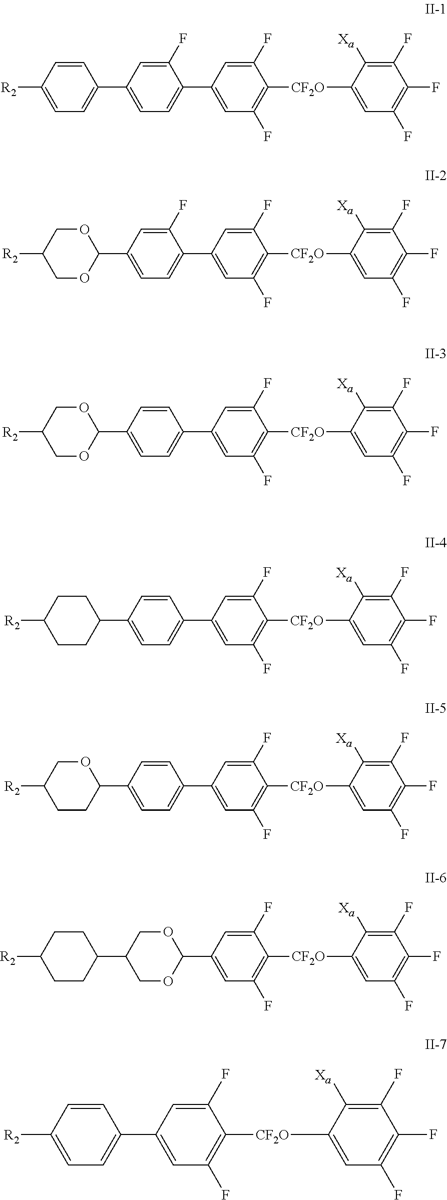

wherein R₂ represents alkyl with a carbon atom number of 1-15, and one or more non-adjacent —CH₂- in R₂ are optionally substituted with cyclopentylene or cyclopropylene; and Xa represents —H or —CH₃.

In the liquid crystal composition of the present invention, preferably, the above compound represented by Formula II-1 is selected from the group consisting of compounds represented by the following Formulas II-1-1 to II-1-12,

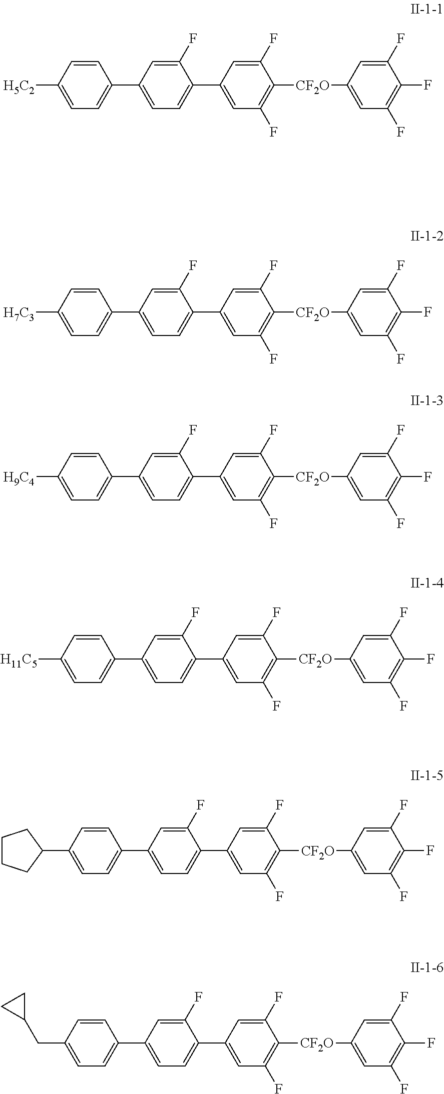

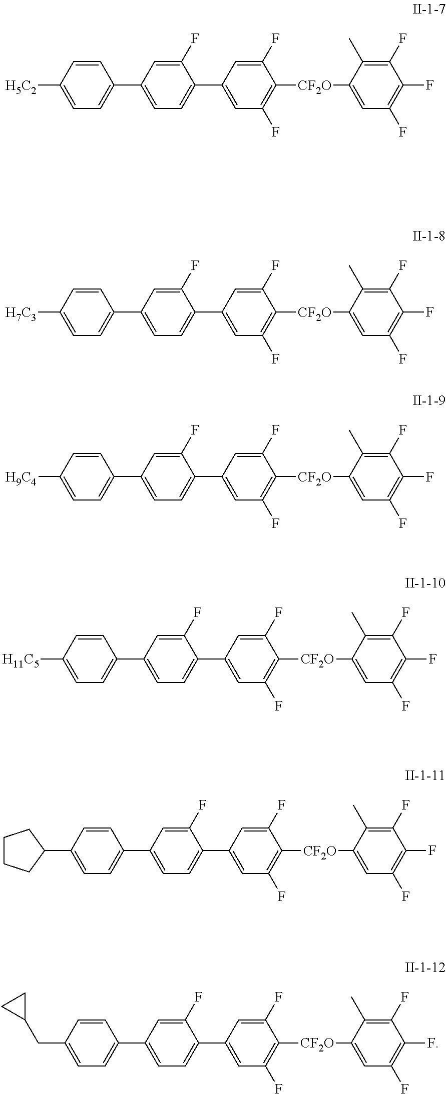

In the liquid crystal composition of the present invention, preferably, the mass content of the above compound represented by Formula II-1 is 2-20%.

In the liquid crystal composition of the present invention, preferably, the above compound represented by Formula II-1 is selected from the group consisting of compounds represented by Formulas II-1-2 to II-1-6 and II-1-8, and the mass content of each of the compounds represented by Formulas II-1-2 to II-1-6 and II-1-8 is preferably 2-5%.

In the liquid crystal composition of the present invention, preferably, the above compound represented by Formula II-2 is selected from the group consisting of compounds represented by the following Formulas II-2-1 to II-2-8,

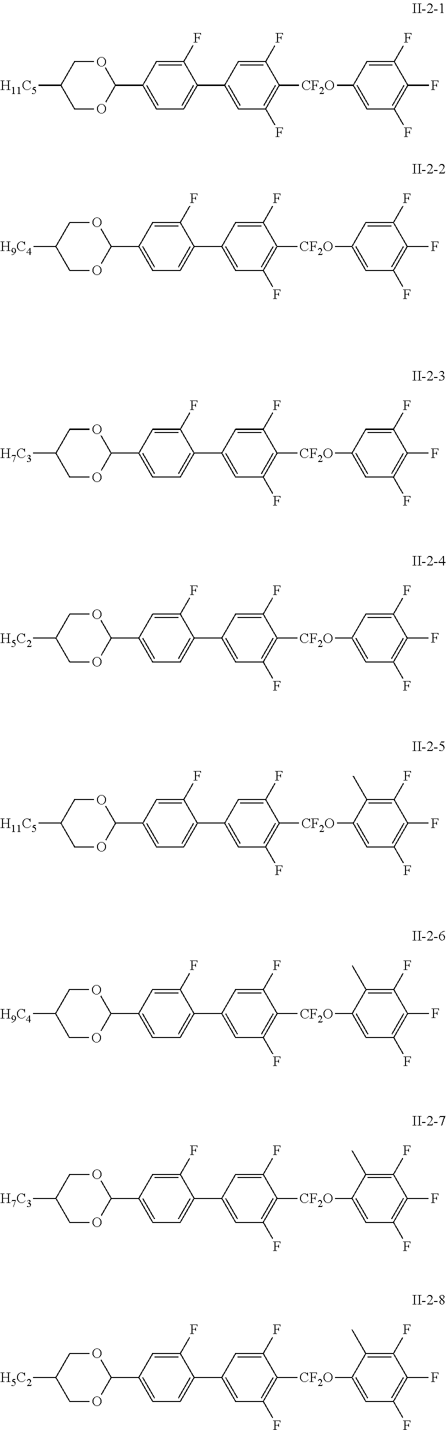

In the liquid crystal composition of the present invention, preferably, the mass content of the above compound represented by Formula II-2 is 1-15%; and further preferably, the mass content of the above compound represented by Formula II-2 is 2-10%.

In the liquid crystal composition of the present invention, preferably, the mass content of the above compound represented by Formula II-2-1 is 1-6%, and further preferably, the mass content of the compound represented by Formula II-2-1 is 2-5%; preferably, the mass content of the above compound represented by Formula II-2-2 is 1-6%, and further preferably, the mass content of the compound represented by Formula II-2-2 is 2-5%; preferably, the mass content of the above compound represented by Formula II-2-3 is 1-6%, and further preferably, the mass content of the compound represented by Formula II-2-3 is 2-5%; preferably, the mass content of the above compound represented by Formula II-2-4 is 1-4%; preferably, the mass content of the above compound represented by Formula II-2-5 is 1-4%; preferably, the mass content of the above compound represented by Formula II-2-6 is 1-6%, and further preferably, the mass content of the compound represented by Formula II-2-6 is 2-5%; preferably, the mass content of the above compound represented by Formula II-2-7 is 1-6%, and further preferably, the mass content of the compound represented by Formula II-2-7 is 2-5%; and preferably, the mass content of the above compound represented by Formula II-2-8 is 1-4%.

In the liquid crystal composition of the present invention, preferably, the above compound represented by Formula II-3 is selected from the group consisting of compounds represented by the following Formulas II-3-1 to II-3-10,

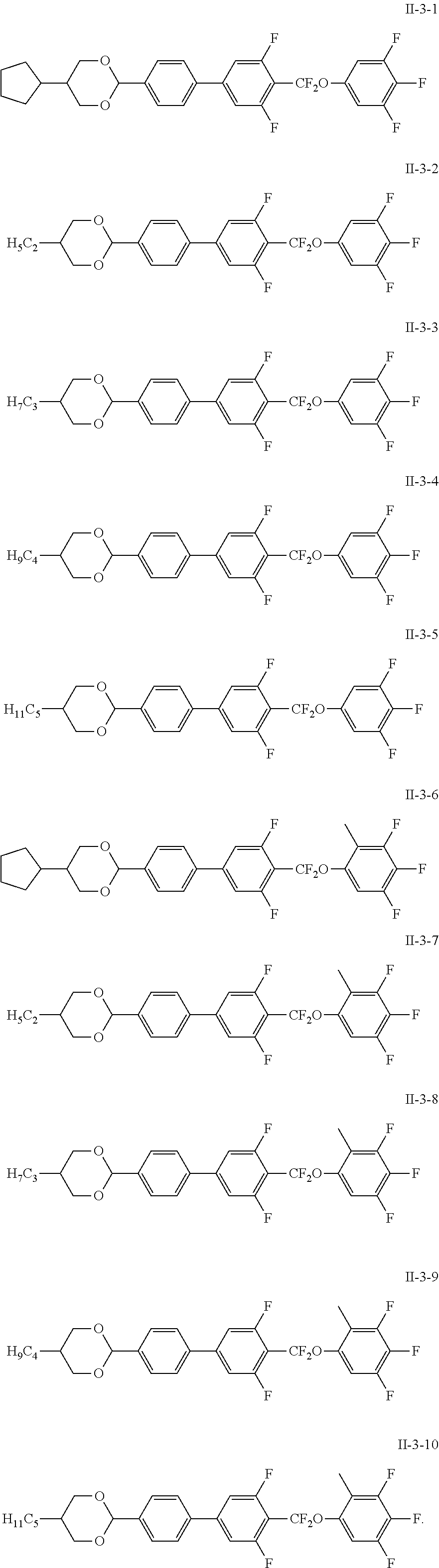

In the liquid crystal composition of the present invention, preferably, the mass content of the above compound represented by Formula II-3 is 1-15%; and further preferably, the mass content of the above compound represented by Formula II-3 is 1-10%.

In the liquid crystal composition of the present invention, preferably, the above compound represented by Formula II-3 is selected from the group consisting of compounds represented by Formulas II-3-2 to II-3-4.

In the liquid crystal composition of the present invention, preferably, the mass content of the above compound represented by Formula II-3-2 is 1-5%, and further preferably, the mass content of the compound represented by Formula II-3-2 is 1-3%; preferably, the mass content of the above compound represented by Formula II-3-3 is 1-6%, and further preferably, the mass content of the compound represented by Formula II-3-3 is 2-5%; and preferably, the mass content of the above compound represented by Formula II-3-4 is 1-6%, and further preferably, the mass content of the compound represented by Formula II-3-4 is 2-5%.

In the liquid crystal composition of the present invention, preferably, the above compound represented by Formula II-4 is selected from the group consisting of compounds represented by the following Formulas II-4-1 to II-4-10,

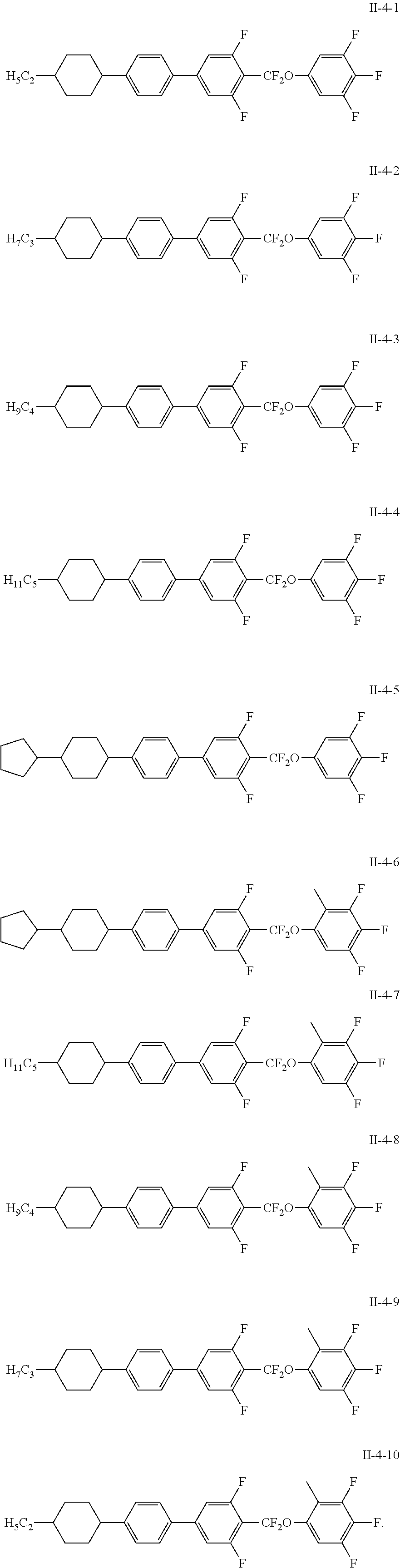

In the liquid crystal composition of the present invention, preferably, the above compound represented by Formula II-4 comprises a compound represented by

Formula II-4-2, and further preferably, the mass content of the compound represented by Formula II-4-2 is 1-6%; and further more preferably, the mass content of the compound represented by Formula II-4-2 is 2-5%.

In the liquid crystal composition of the present invention, preferably, the above compound represented by Formula II-5 is selected from the group consisting of compounds represented by the following Formulas II-5-1 to II-5-10,

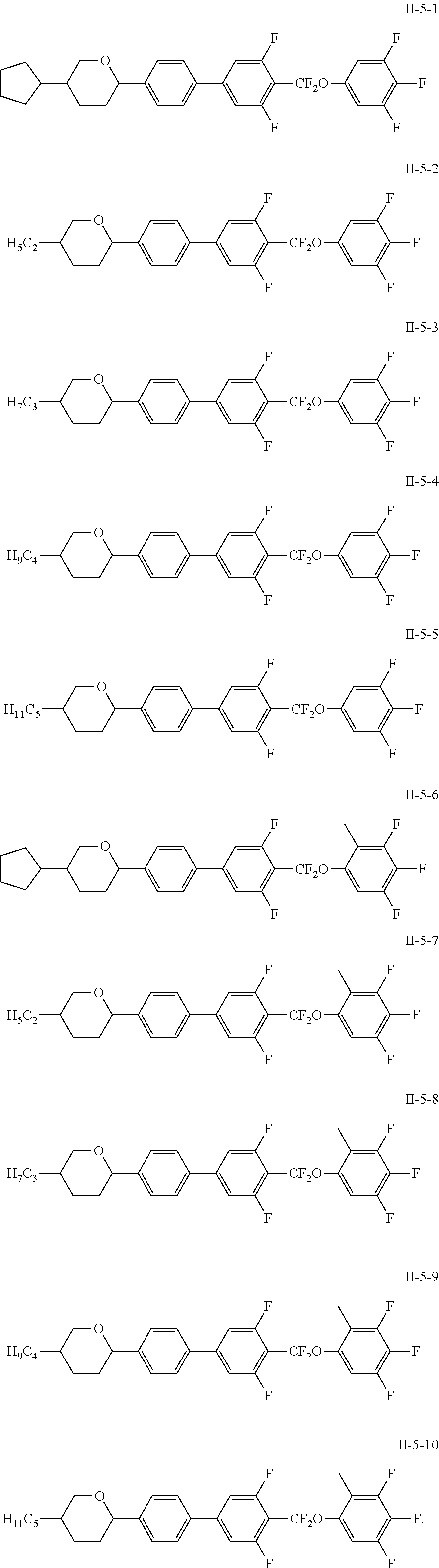

In the liquid crystal composition of the present invention, preferably, the mass content of the above compound represented by Formula II-5 is 1-10%.

In the liquid crystal composition of the present invention, preferably, the above compound represented by Formula II-5 is selected from the group consisting of compounds represented by Formulas II-5-1 to II-5-5.

In the liquid crystal composition of the present invention, preferably, the mass content of each of the above compounds represented by Formulas II-5-1 to II-5-5 is 1-6%; and further preferably, the mass content of each of the compounds is 2-5%.

In the liquid crystal composition of the present invention, preferably, the above compound represented by Formula II-6 is selected from the group consisting of compounds represented by the following Formulas II-6-1 to II-6-8,

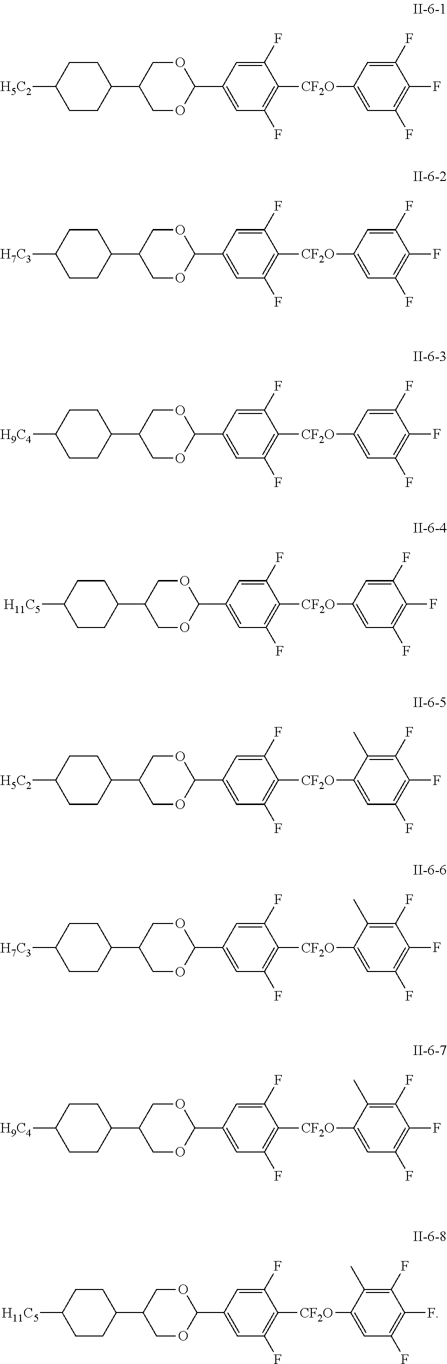

In the liquid crystal composition of the present invention, preferably, the mass content of the above compound represented by Formula II-6 is 1-10%.

In the liquid crystal composition of the present invention, preferably, the mass content of the above compound represented by Formula II-6-1 is 1-6%, and further preferably, the mass content of the compound represented by Formula II-6-1 is 2-5%; preferably, the mass content of the above compound represented by Formula II-6-2 is 1-6%, and further preferably, the mass content of the compound represented by Formula II-6-2 is 2-5%; preferably, the mass content of the above compound represented by Formula II-6-3 is 1-6%, and further preferably, the mass content of the compound represented by Formula II-6-3 is 2-5%; preferably, the mass content of the above compound represented by Formula II-6-4 is 2-5%; preferably, the mass content of the above compound represented by Formula II-6-5 is 1-6%, and further preferably, the mass content of the compound represented by Formula II-6-5 is 2-5%; and preferably, the mass content of the above compound represented by Formula II-6-6 is 1-6%, and further preferably, the mass content of the compound represented by Formula II-6-6 is 2-5%.

In the liquid crystal composition of the present invention, preferably, the above compound represented by Formula II-7 is selected from the group consisting of compounds represented by the following Formulas II-7-1 to II-7-10,

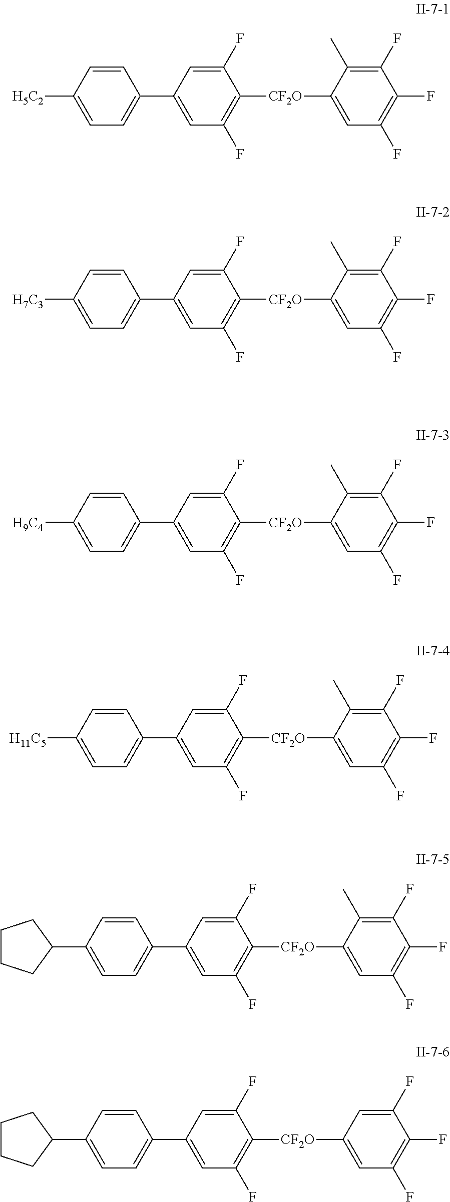

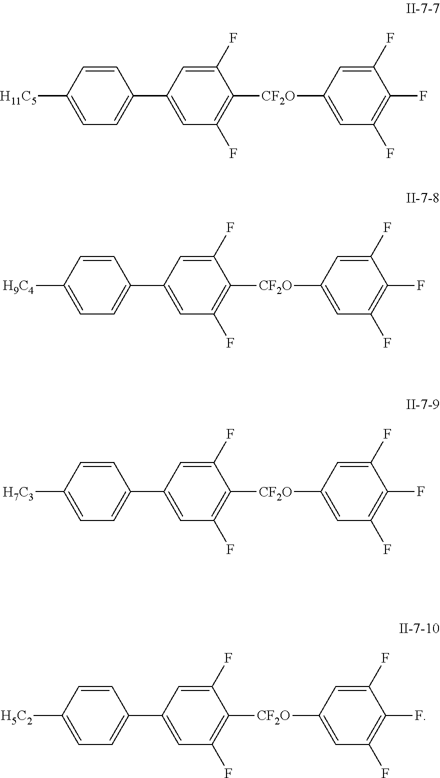

In the liquid crystal composition of the present invention, preferably, the mass content of the above compound represented by Formula II-7 is 1-25%; and further preferably, the mass content of the compound represented by Formula II-7 is 3-10%.

In the liquid crystal composition of the present invention, preferably, the mass content of the above compound represented by Formula II-7-1 is 1-20%, and further preferably, the mass content of the compound represented by Formula II-7-1 is 1-10%; preferably, the mass content of the above compound represented by Formula II-7-2 is 1-20%, and further preferably, the mass content of the compound represented by Formula II-7-2 is 1-10%; preferably, the mass content of the above compound represented by Formula II-7-6 is 1-20%, and further preferably, the mass content of the compound represented by Formula II-7-6 is 1-10%; and preferably, the mass content of the above compound represented by Formula II-7-9 is 1-20%, and further preferably, the mass content of the compound represented by Formula II-7-9 is 1-10%.

In the liquid crystal composition of the present invention, preferably, the above compound represented by Formula III is selected from the group consisting of compounds represented by the following Formulas III-1 to III-4,

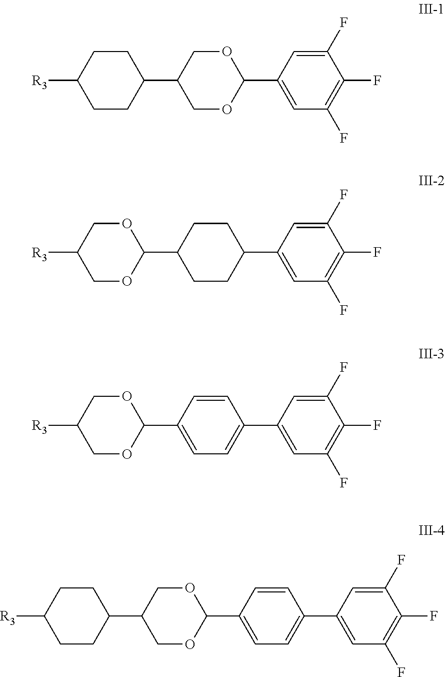

wherein R₃ represents alkyl with a carbon atom number of 1-15 or alkenyl with a carbon atom number of 2-15.

In the liquid crystal composition of the present invention, preferably, the above compound represented by Formula III-1 is selected from the group consisting of compounds represented by the following Formulas III-1-1 to III-1-4,

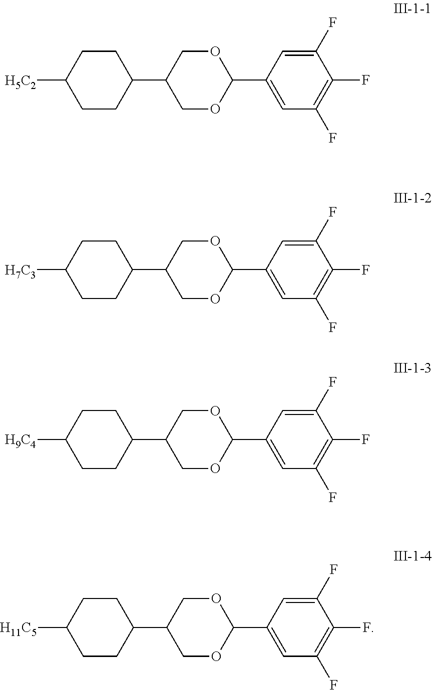

In the liquid crystal composition of the present invention, preferably, the mass content of the above compound represented by Formula III-1-2 is 1-10%; and further preferably, the mass content of the above compound represented by Formula III-1-2 is 5-10%.

In the liquid crystal composition of the present invention, preferably, the above compound represented by Formula III-2 is selected from the group consisting of compounds represented by the following Formulas III-2-1 to III-2-4,

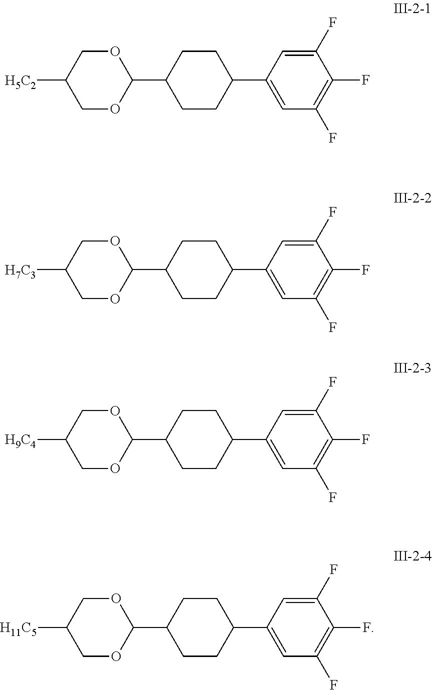

In the liquid crystal composition of the present invention, preferably, the mass content of the above compound represented by Formula III-2-4 is 0.01-10%, and further preferably, the mass content of the above compound represented by Formula III-2-4 is 0.03-5%.

In the liquid crystal composition of the present invention, preferably, the above compound represented by Formula III-3 is selected from the group consisting of compounds represented by the following Formulas III-3-1 to III-3-4,

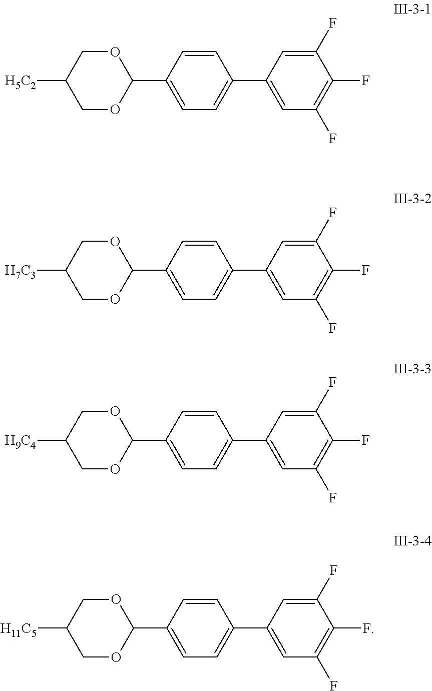

In the liquid crystal composition of the present invention, preferably, the mass content of the above compound represented by Formula III-3-2 is 1-10%, and further preferably, the mass content of the above compound represented by Formula III-3-2 is 1-5%; and preferably, the mass content of the above compound represented by Formula III-3-3 is 1-10%, and further preferably, the mass content of the above compound represented by Formula III-3-3 is 1-5%.

In the liquid crystal composition of the present invention, preferably, the above compound represented by Formula III-4 is selected from the group consisting of compounds represented by the following Formulas III-4-1 to III-4-4,

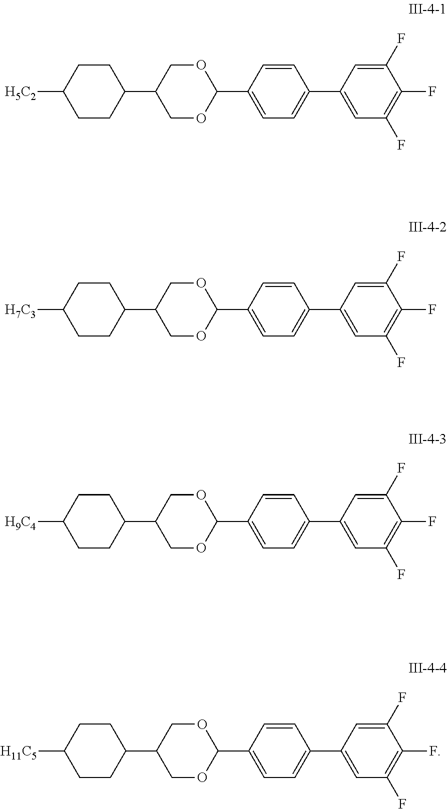

In the liquid crystal composition of the present invention, preferably, the mass content of the above compound represented by Formula III-4-2 is 1-5%; and preferably, the mass content of the above compound represented by Formula III-4-3 is 1-5%.

In the liquid crystal composition of the present invention, preferably, the above liquid crystal composition further comprises one or more compounds represented by Formula IV,

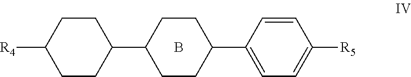

wherein R₄ represents alkyl with a carbon atom number of 1-15, alkenyl with a carbon atom number of 2-15, or alkoxy with a carbon atom number of 1-15; R₅ represents alkyl with a carbon atom number of 1-15, alkenyl with a carbon atom number of 2-15, alkoxy with a carbon atom number of 1-15, —F, —CF₃, or —OCF₃;

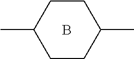

represents

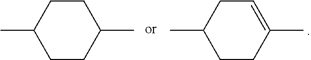

In the liquid crystal composition of the present invention, preferably, the above compound represented by Formula IV is selected from the group consisting of compounds represented by the following Formulas IV-1 to IV-2,

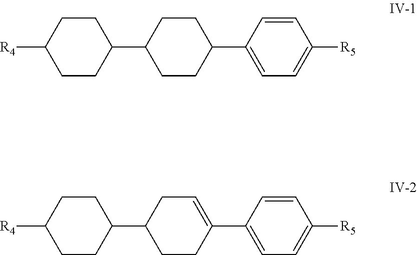

wherein R₄ represents alkyl with a carbon atom number of 1-15, alkenyl with a carbon atom number of 2-15, or alkoxy with a carbon atom number of 1-15; and R₅ represents alkyl with a carbon atom number of 1-15, alkenyl with a carbon atom number of 2-15, alkoxy with a carbon atom number of 1-15, —F, —CF₃, or —OCF₃.

In the liquid crystal composition of the present invention, preferably, the above compound represented by Formula IV-1 is selected from the group consisting of compounds represented by the following Formulas IV-1-1 to IV-1-13,

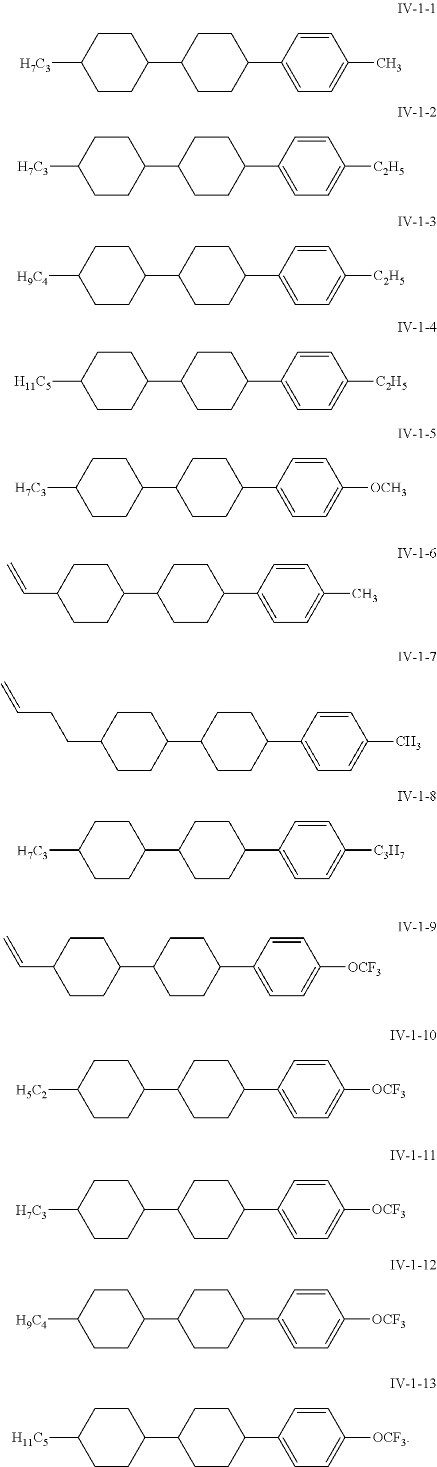

In the liquid crystal composition of the present invention, preferably, the mass content of the above compound represented by Formula IV-1 is 1-30%; and further preferably, the mass content of the compound represented by Formula IV-1 is 1-20%.

In the liquid crystal composition of the present invention, preferably, the mass content of the above compound represented by Formula IV-1-1 is 1-15%, and further preferably, the mass content of the compound represented by Formula IV-1-1 is 1-10%; preferably, the mass content of the above compound represented by Formula IV-1-6 is 1-20%, and further preferably, the mass content of the compound represented by Formula IV-1-6 is 1-12%; preferably, the mass content of the above compound represented by Formula IV-1-7 is 1-20%, and further preferably, the mass content of the compound represented by Formula IV-1-7 is 1-12%; preferably, the mass content of the above compound represented by Formula IV-1-8 is 1-10%; preferably, the mass content of the above compound represented by Formula IV-1-9 is 1-10%; preferably, the mass content of the above compound represented by Formula IV-1-11 is 1-10%; and preferably, the mass content of the above compound represented by Formula IV-1-13 is 1-5%.

In the liquid crystal composition of the present invention, preferably, the above compound represented by Formula IV-2 is selected from the group consisting of compounds represented by the following Formulas IV-2-1 and IV-2-16,

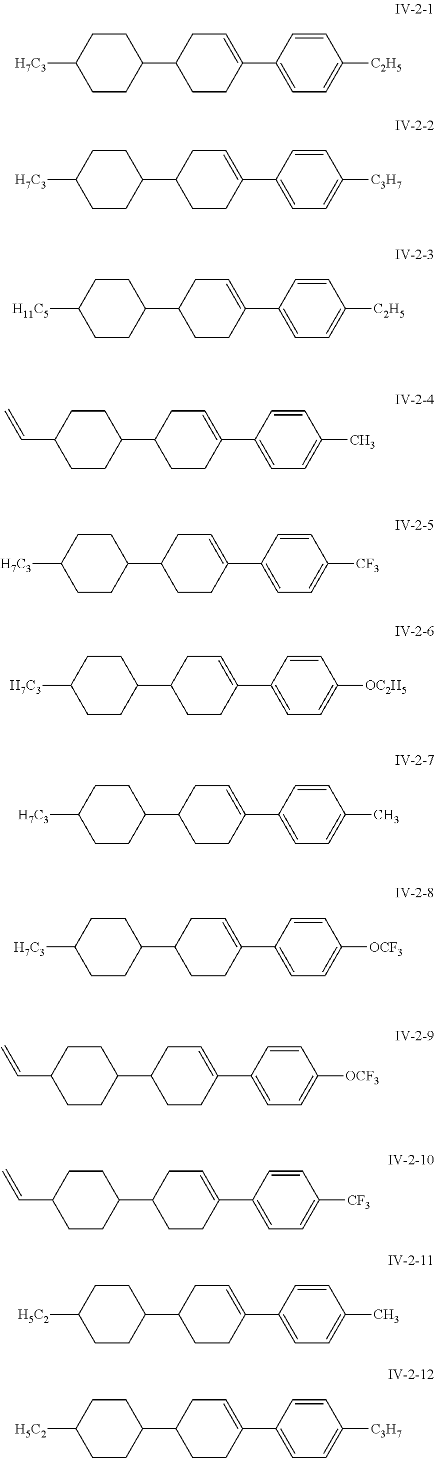

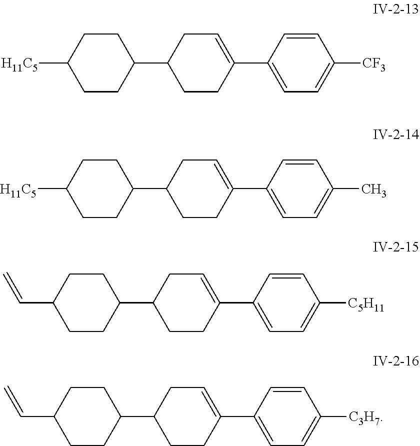

In the liquid crystal composition of the present invention, preferably, the mass content of the above compound represented by Formula IV-2 is ≤30%; and further preferably, the mass content of the compound represented by Formula IV-2 is 2-25%.

In the liquid crystal composition of the present invention, preferably, the above compound represented by Formula IV-2 is selected from the group consisting of compounds represented by Formulas IV-2-1, IV-2-2, IV-2-4, IV-2-7, IV-2-8, IV-2-9, and IV-2-12; further preferably, the mass content of each of the compounds represented by Formulas IV-2-1, IV-2-2, IV-2-4, IV-2-7, IV-2-8, IV-2-9, and IV-2-12 is 0.5-10%; and further more preferably, the mass content of each of the compounds is 2-8%.

In the liquid crystal composition of the present invention, preferably, the above liquid crystal composition further comprises one or more compounds represented by Formula V,

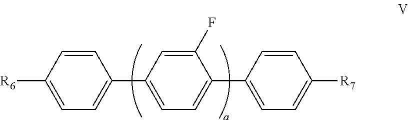

wherein R₆ represents alkyl with a carbon atom number of 1-15, alkenyl with a carbon atom number of 2-15, or alkoxy with a carbon atom number of 1-15; R₇ represents alkyl with a carbon atom number of 1-15, alkenyl with a carbon atom number of 2-15, alkoxy with a carbon atom number of 1-15, —F, —CF₃, or —OCF₃; a represents 0 or 1.

In the liquid crystal composition of the present invention, preferably, the above compound represented by Formula V is selected from the group consisting of compounds represented by the following Formulas V-1 to V-2,

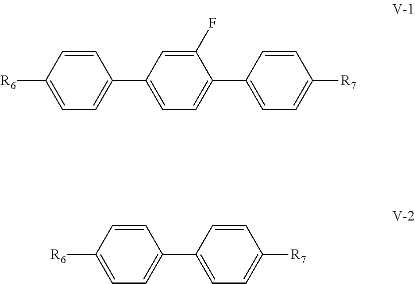

wherein R₆ represents alkyl with a carbon atom number of 1-15, alkenyl with a carbon atom number of 2-15, or alkoxy with a carbon atom number of 1-15; and R₇ represents alkyl with a carbon atom number of 1-15, alkenyl with a carbon atom number of 2-15, alkoxy with a carbon atom number of 1-15, —F, —CF₃, or —OCF₃.

In the liquid crystal composition of the present invention, preferably, the above compound represented by Formula V-1 is selected from the group consisting of compounds represented by the following Formulas V-1-1 to V-1-31,

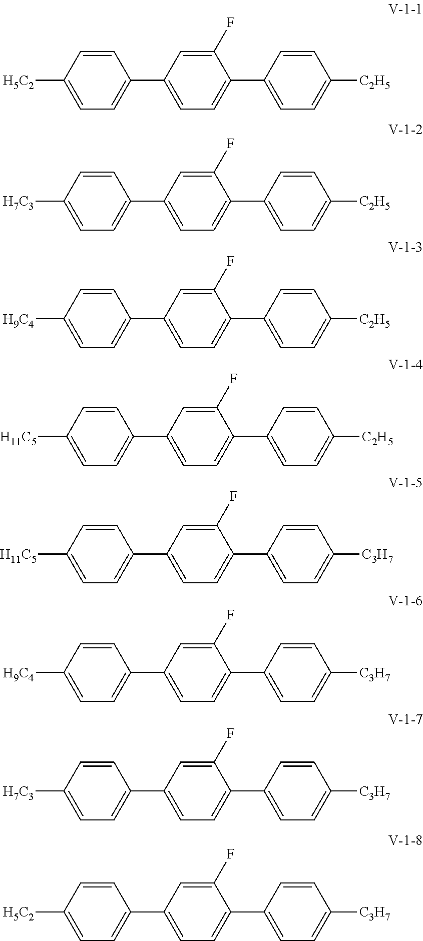

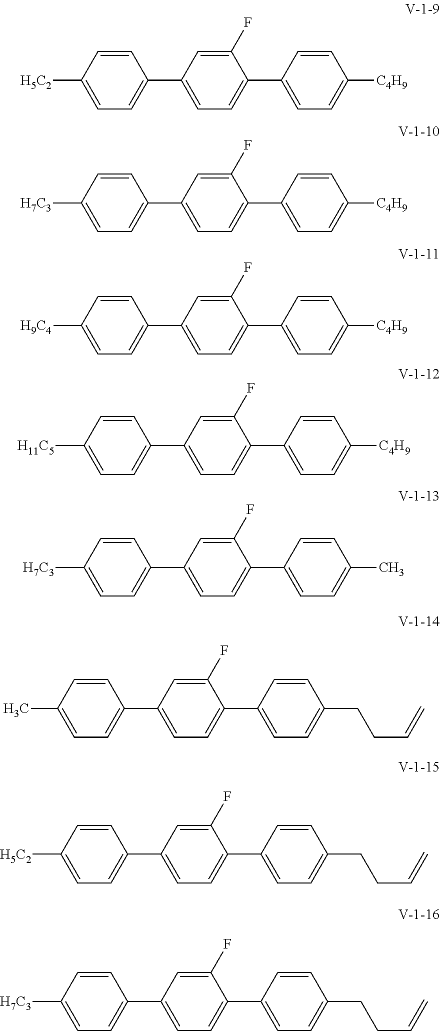

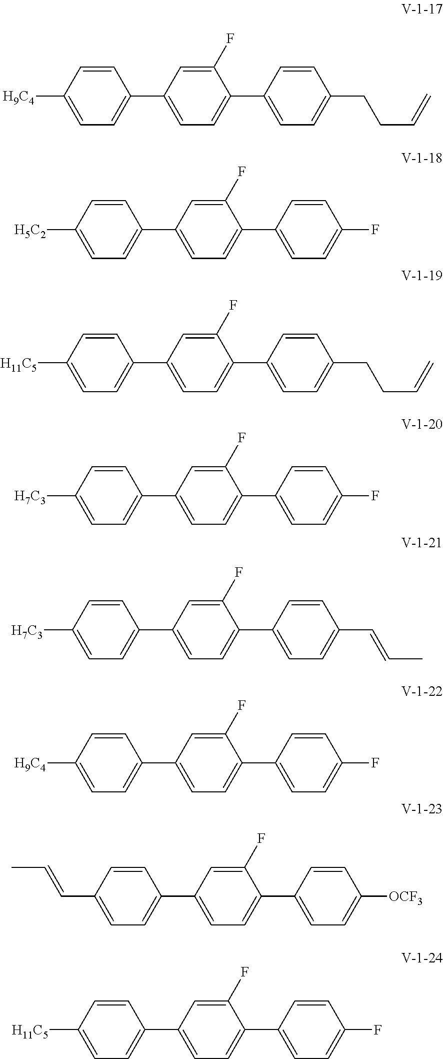

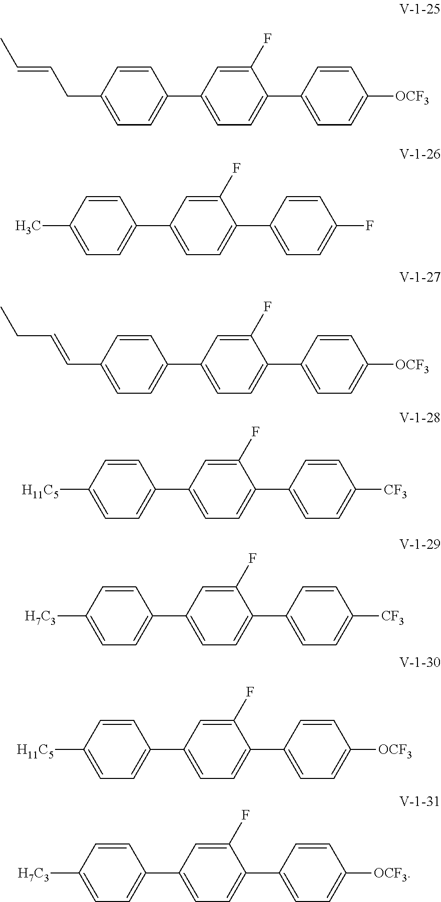

In the liquid crystal composition of the present invention, preferably, the mass content of the above compound represented by Formula V-1 is 5-30%.

In the liquid crystal composition of the present invention, preferably, the mass content of the above compound represented by Formula V-1-2 is 5-10%; preferably, the mass content of the above compound represented by Formula V-1-4 is 5-10%; preferably, the mass content of the above compound represented by Formula V-1-8 is 5-10%; preferably, the mass content of the above compound represented by Formula V-1-14 is 5-10%; preferably, the mass content of the above compound represented by Formula V-1-15 is 2-15%; preferably, the mass content of the above compound represented by Formula V-1-16 is 5-10%; preferably, the mass content of the above compound represented by Formula V-1-18 is 5-10%; preferably, the mass content of the above compound represented by Formula V-1-20 is 5-10%; preferably, the mass content of the above compound represented by Formula V-1-22 is 5-10%; and preferably, the mass content of the above compound represented by Formula V-1-24 is 0.5-10%.

In the liquid crystal composition of the present invention, preferably, the above compound represented by Formula V-2 is selected from the group consisting of compounds represented by the following Formulas V-2-1 and V-2-6,

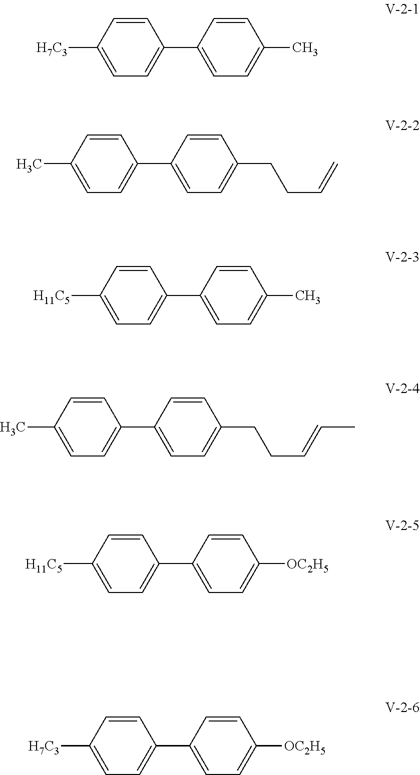

In the liquid crystal composition of the present invention, preferably, the mass content of the above compound represented by Formula V-2 is 1-20%.

In the liquid crystal composition of the present invention, preferably, the mass content of the above compound represented by Formula V-2-2 is 1-10%; and preferably, the mass content of the compound represented by Formula V-2-4 is 1-10%.

In the liquid crystal composition of the present invention, preferably, the above liquid crystal composition further comprises one or more compounds represented by Formula VI,

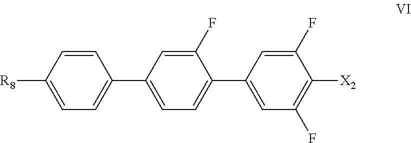

wherein R₅ represents alkyl with a carbon atom number of 1-15 or alkenyl with a carbon atom number of 2-15; and X₂ represents —CF₃ or —OCF₃.

In the liquid crystal composition of the present invention, preferably, the above compound represented by Formula VI is selected from the group consisting of compounds represented by the following Formulas VI-1 to VI-10,

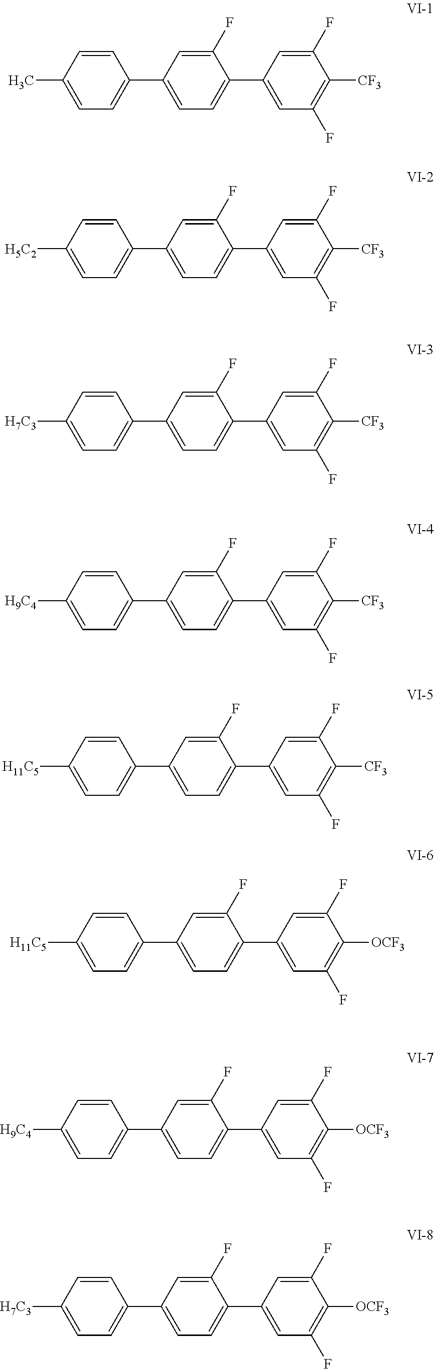

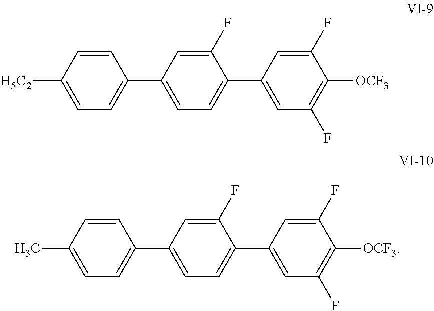

In the liquid crystal composition of the present invention, preferably, the mass content of the above compound represented by Formula VI-2 is 2-15%; preferably, the mass content of the above compound represented by Formula VI-3 is 2-7%; preferably, the mass content of the above compound represented by Formula VI-4 is 2-7%; preferably, the mass content of the above compound represented by Formula VI-5 is 2-7%; and preferably, the mass content of the above compound represented by Formula VI-7 is 2-7%.

In the liquid crystal composition of the present invention, preferably, the above liquid crystal composition further comprises one or more compounds represented by Formula VII,

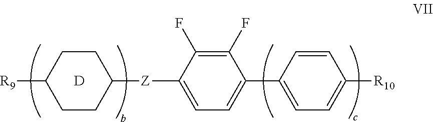

wherein R₉ and R₁₀ each independently represent alkyl with a carbon atom number of 1-15, alkenyl with a carbon atom number of 2-15, or alkoxy with a carbon atom number of 1-15; and one or more non-adjacent —CH₂- in R₉ are optionally substituted with cyclopentylene or cyclopropylene;
Z represents a single bond, —CH₂ —CH₂-, —CH₂O-, or —CF₂O-; b represents 1 or 2; c represents 0 or 1; and

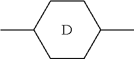

represents

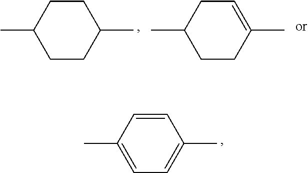

and when b represents 2, two

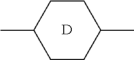

are optionally the same or different.

In the liquid crystal composition of the present invention, preferably, the above compound represented by Formula VII is selected from the group consisting of compounds represented by the following Formulas VII-1 to VII-11,

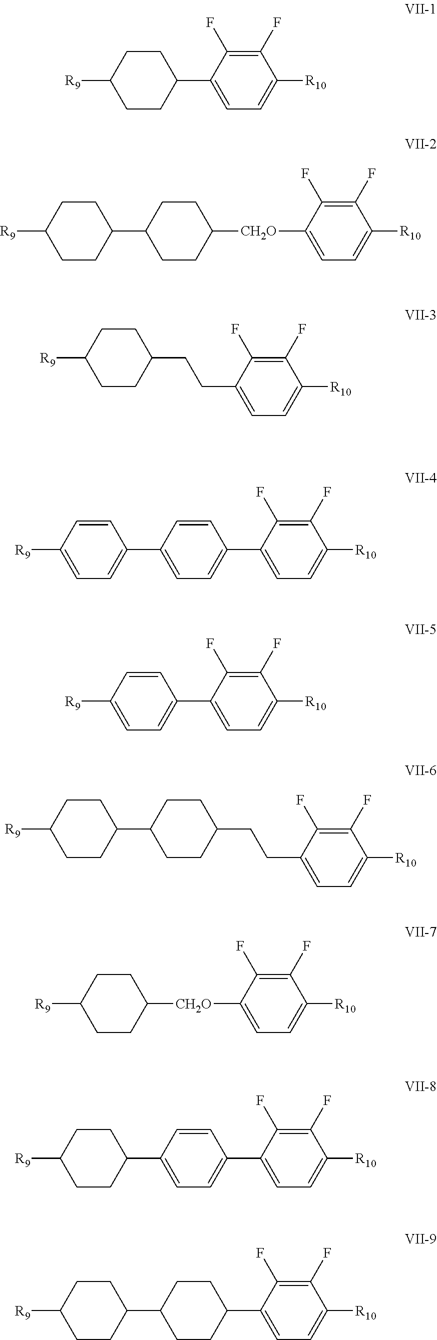

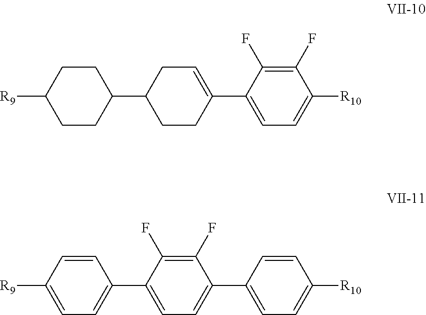

wherein R₉ and R₁₀ each independently represent alkyl with a carbon atom number of 1-15, alkenyl with a carbon atom number of 2-15, or alkoxy with a carbon atom number of 1-15; and one or more non-adjacent —CH₂- in R₉ are optionally substituted with cyclopentylene or cyclopropylene.

In the liquid crystal composition of the present invention, preferably, the above compound represented by Formula VII-1 is selected from the group consisting of compounds represented by the following Formulas VII-1-1 to VII-1-9,

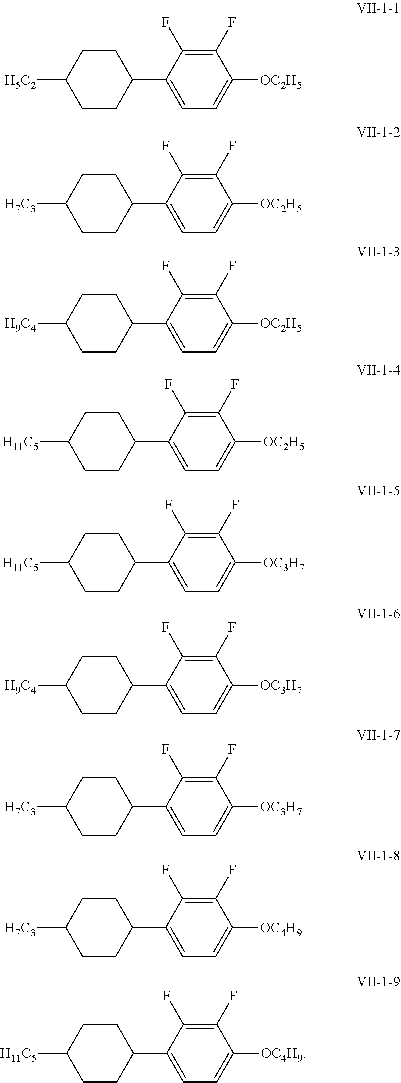

In the liquid crystal composition of the present invention, preferably, the mass content of the above compound represented by Formula VII-1-2 is 1-10%; and further preferably, the mass content of the compound represented by Formula VII-1-2 is 1-5%.

In the liquid crystal composition of the present invention, preferably, the above compound represented by Formula VII-2 is selected from the group consisting of compounds represented by the following Formulas VII-2-1 and VII-2-12,

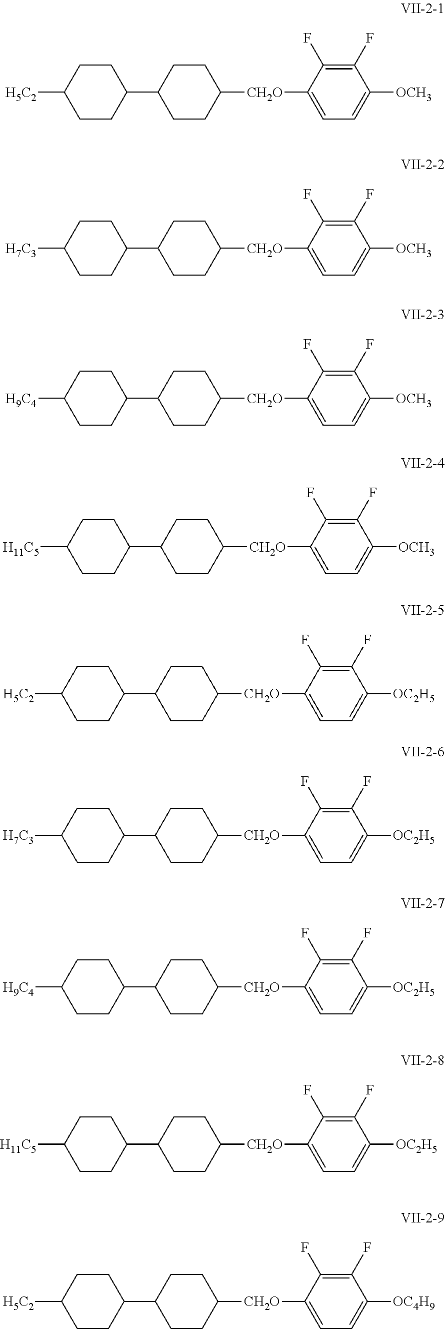

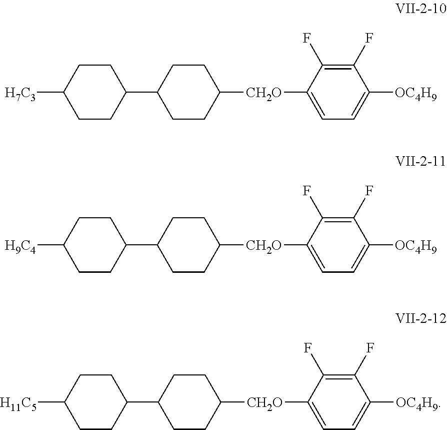

In the liquid crystal composition of the present invention, preferably, the above compound represented by Formula VII-4 is selected from the group consisting of compounds represented by the following Formulas VII-4-1 and VII-4-16,

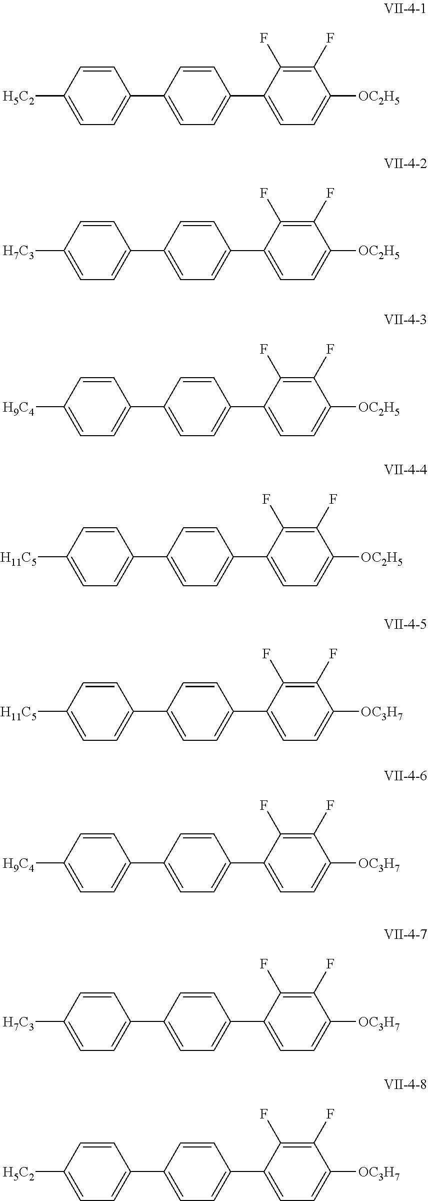

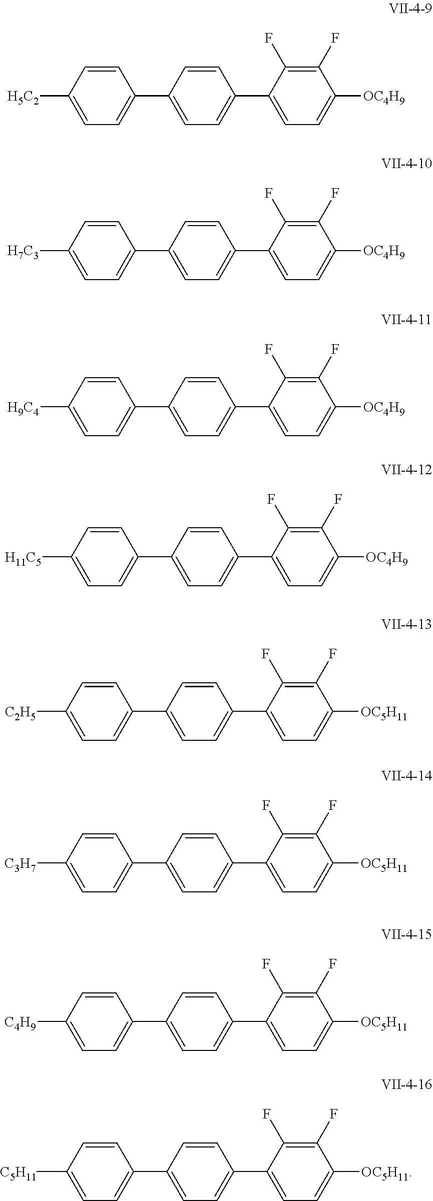

In the liquid crystal composition of the present invention, preferably, the above compound represented by Formula VII-5 is selected from the group consisting of compounds represented by the following Formulas VII-5-1 and VII-5-8,

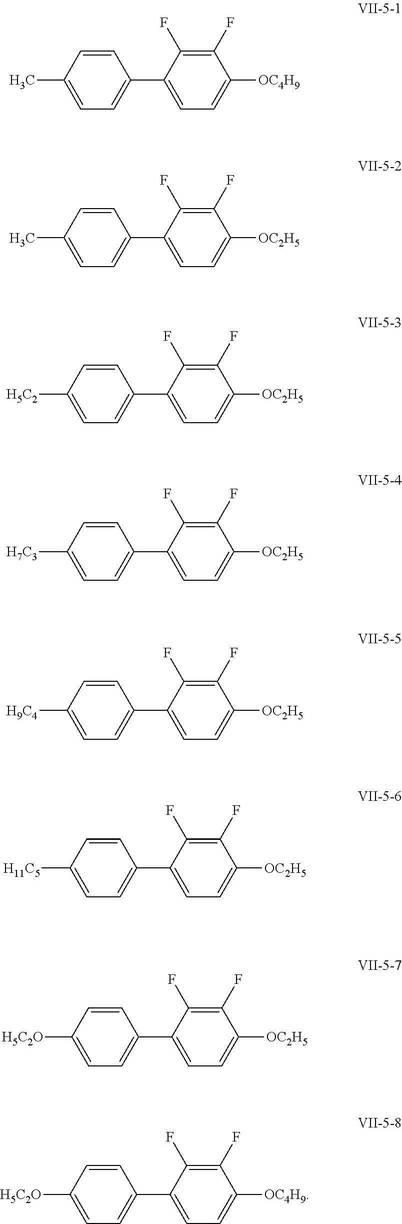

In the liquid crystal composition of the present invention, preferably, the above compound represented by Formula VII-6 is selected from the group consisting of compounds represented by the following Formulas VII-6-1 and VII-6-7,

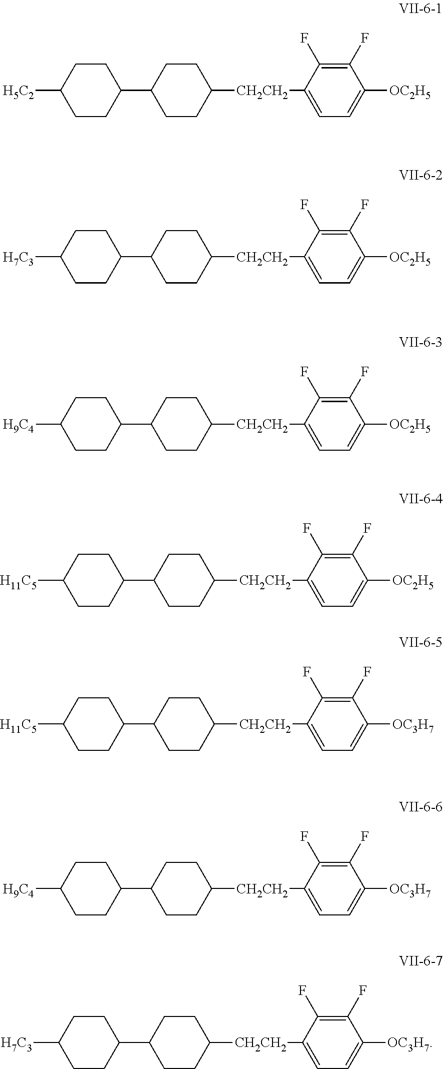

In the liquid crystal composition of the present invention, preferably, the above compound represented by Formula VII-7 is selected from the group consisting of compounds represented by the following Formulas VII-7-1 and VII-7-11,

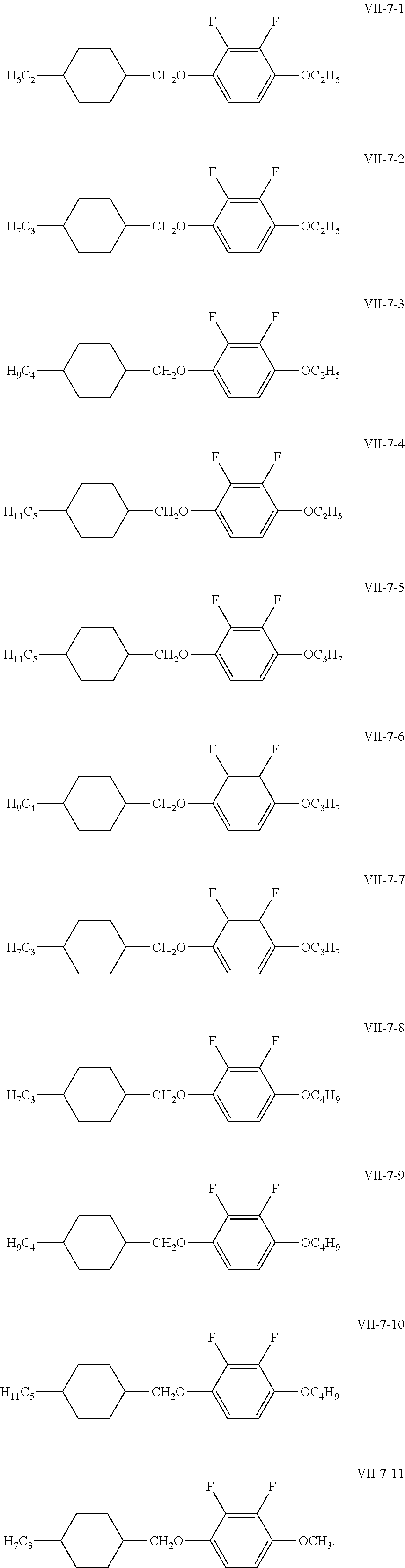

In the liquid crystal composition of the present invention, preferably, the above compound represented by Formula VII-8 is selected from the group consisting of compounds represented by the following Formulas VII-8-1 and VII-8-25,

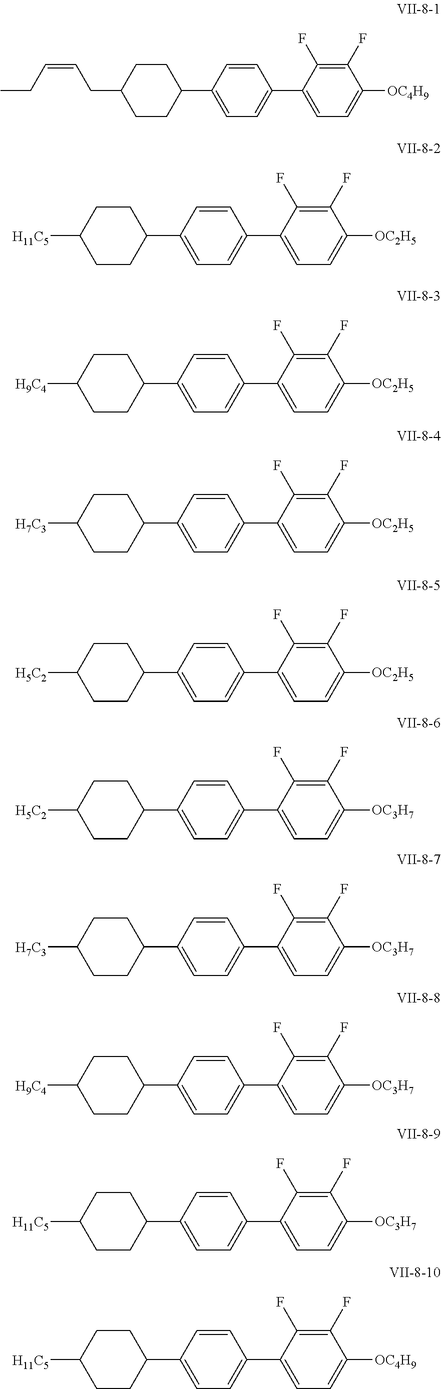

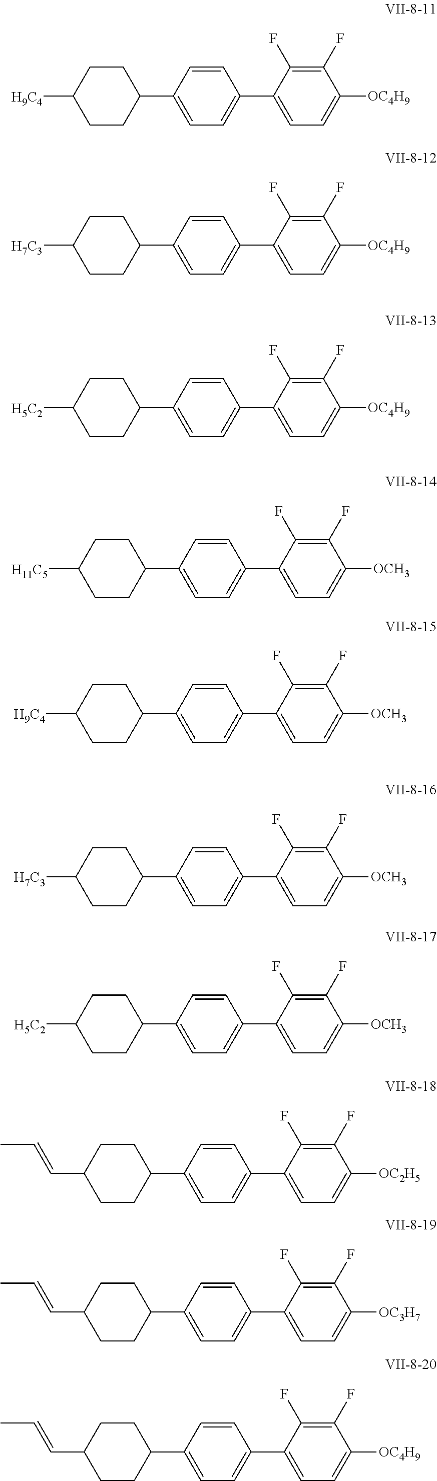

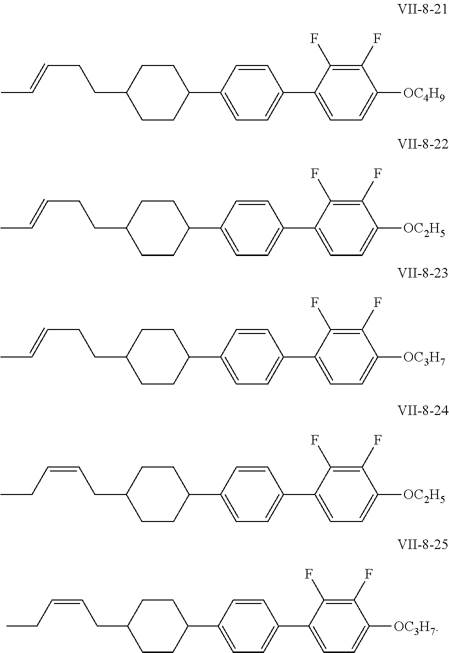

In the liquid crystal composition of the present invention, preferably, the mass content of the above compound represented by Formula VII-8-4 is 1-10%; and further preferably, the mass content of the compound represented by Formula VII-8-4 is 1-5%. In the liquid crystal composition of the present invention, preferably, the mass content of the above compound represented by Formula VII-8-5 is 1-10%; and further preferably, the mass content of the compound represented by Formula VII-8-5 is 1-5%.

In the liquid crystal composition of the present invention, preferably, the above compound represented by Formula VII-9 is selected from the group consisting of compounds represented by the following Formulas VII-9-1 and VII-9-18,

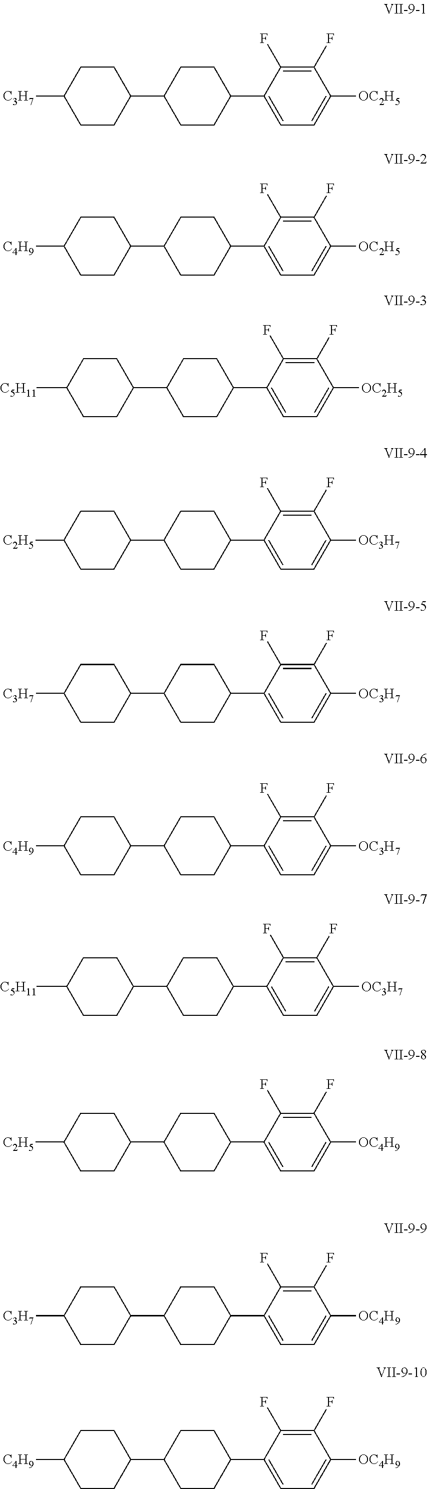

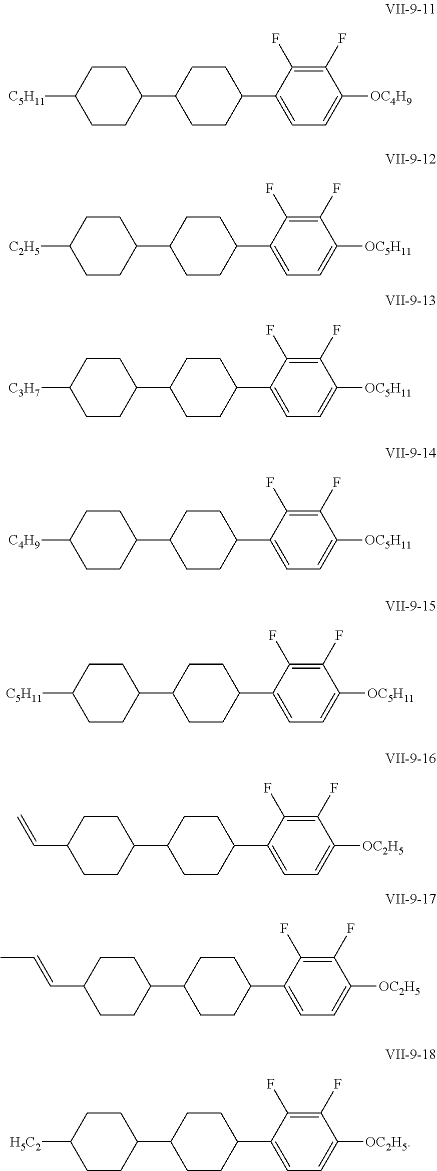

In the liquid crystal composition of the present invention, preferably, the mass content of the above compound represented by Formula VII-9-1 is 1-10%; and further preferably, the mass content of the compound represented by Formula VII-9-1 is 1-6%. In the liquid crystal composition of the present invention, preferably, the mass content of the above compound represented by Formula VII-9-18 is 1-10%; and further preferably, the mass content of the compound represented by Formula VII-9-18 is 1-6%.

In the liquid crystal composition of the present invention, preferably, the above compound represented by Formula VII-10 is selected from the group consisting of compounds represented by the following Formulas VII-10-1 and VII-10-22,

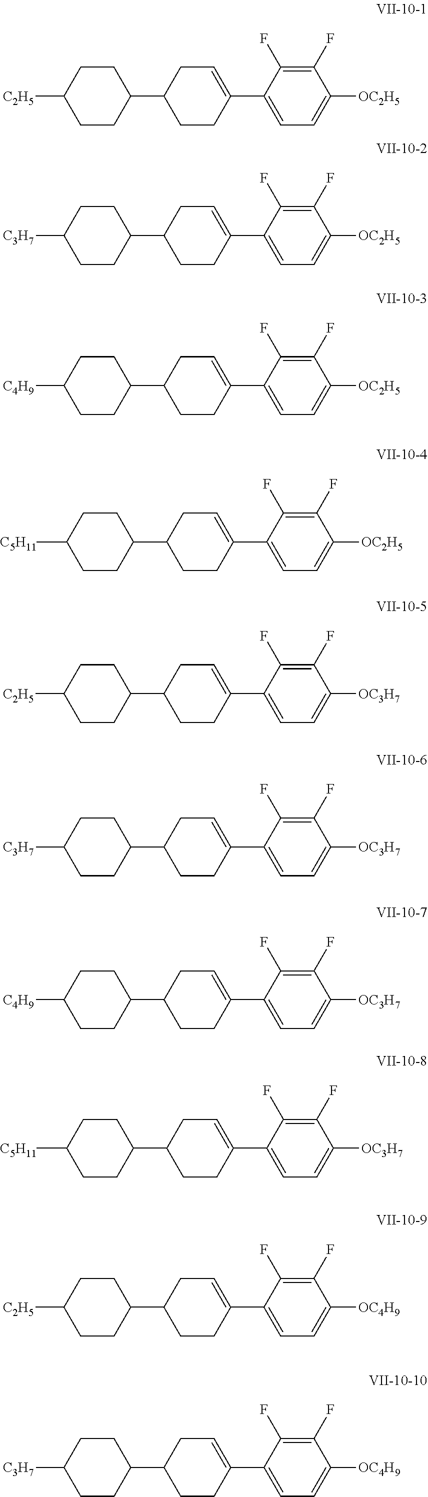

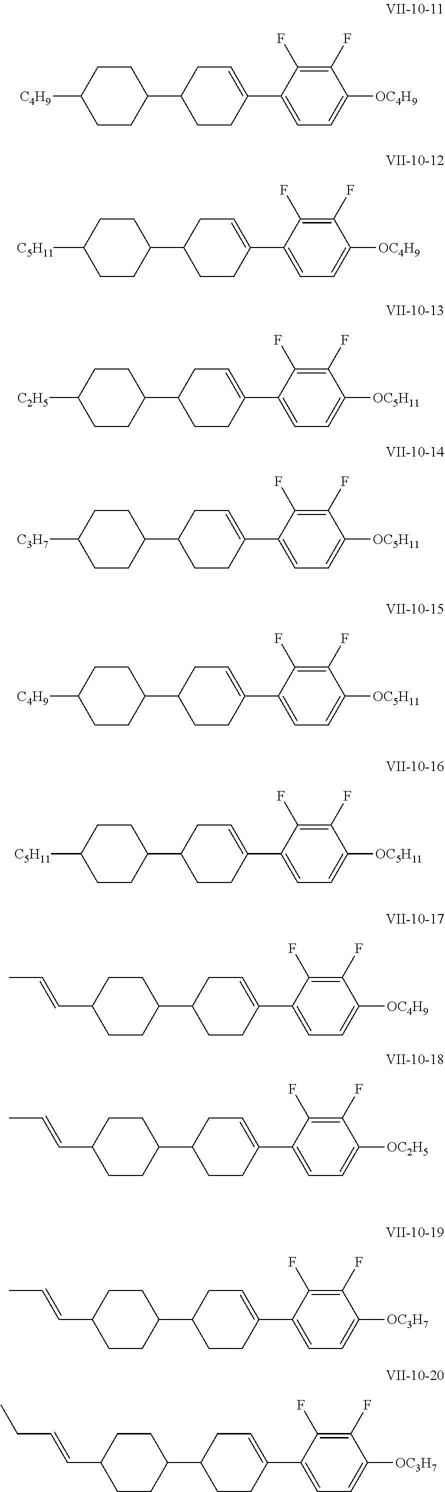

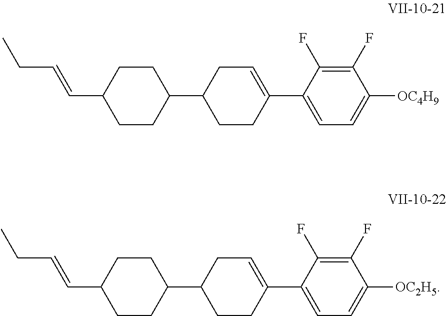

In the liquid crystal composition of the present invention, preferably, the mass content of the above compound represented by Formula VII-10-1 is 1-10%; and further preferably, the mass content of the compound represented by Formula VII-10-1 is 1-6%. In the liquid crystal composition of the present invention, preferably, the mass content of the above compound represented by Formula VII-10-2 is 1-10%; and further preferably, the mass content of the compound represented by Formula VII-10-2 is 1-6%.

In the liquid crystal composition of the present invention, preferably, the above compound represented by Formula VII-11 is selected from the group consisting of compounds represented by the following Formulas VII-11-1 and VII-11-6,

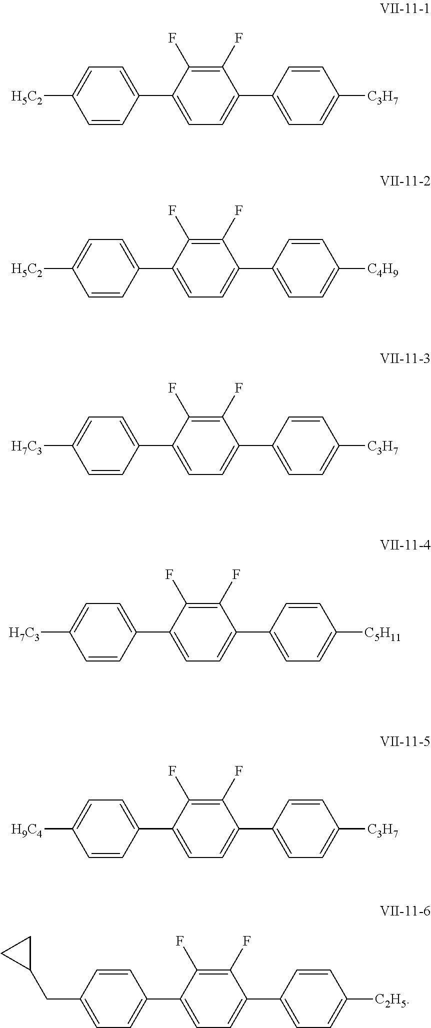

In the liquid crystal composition of the present invention, preferably, the above liquid crystal composition further comprises one or more compounds represented by Formula VIII,

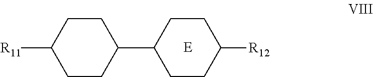

wherein R₁₁ and R₁₂ each independently represent alkyl with a carbon atom number of 1-15, alkoxy with a carbon atom number of 1-15, or alkenyl with a carbon atom number of 2-15; and

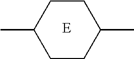

represents

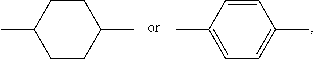

In the liquid crystal composition of the present invention, preferably, the above compound represented by Formula VIII is selected from the group consisting of compounds represented by the following Formulas VIII-1 to VIII-2,

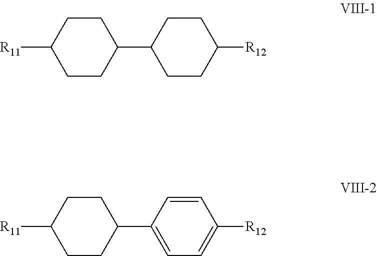

wherein R₁₁ and R₁₂ each independently represent alkyl with a carbon atom number of 1-15, alkoxy with a carbon atom number of 1-15, or alkenyl with a carbon atom number of 2-15.

In the liquid crystal composition of the present invention, preferably, the above compound represented by Formula VIII-1 is selected from the group consisting of compounds represented by the following Formulas VIII-1-1 to VIII-1-7,

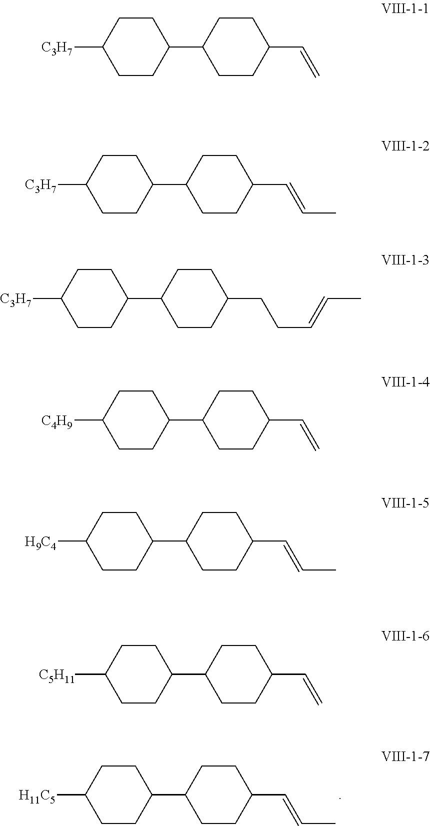

In the liquid crystal composition of the present invention, preferably, the mass content of the above compound represented by Formula VIII-1-1 is 30-45%; preferably, the mass content of the above compound represented by Formula VIII-1-2 is 2-10%; preferably, the mass content of the above compound represented by Formula VIII-1-3 is 2-10%; preferably, the mass content of the above compound represented by Formula VIII-1-5 is 2-5%; and preferably, the mass content of the above compound represented by Formula VIII-1-7 is 2-5%.

In the liquid crystal composition of the present invention, preferably, the above compound represented by Formula VIII-2 is selected from the group consisting of compounds represented by the following Formulas VIII-2-1 to VIII-2-11,

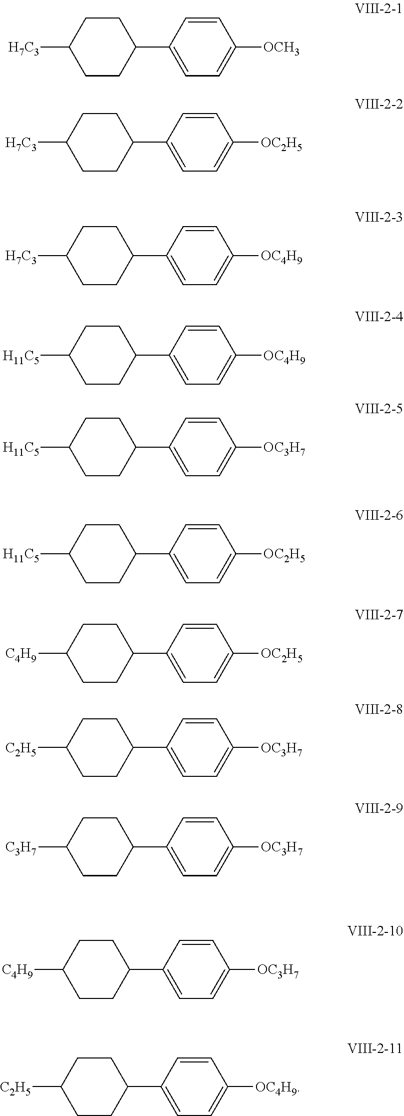

In the liquid crystal composition of the present invention, preferably, the mass content of the compound represented by Formula VIII-2-2 is 1-10%; and preferably, the mass content of the above compound represented by Formula VIII-2-6 is 1-5%.

The liquid crystal composition of the present invention preferably comprises one or more compounds represented by Formulas I-1 and I-2, one or more compounds represented by Formula II-1, one or more compounds represented by Formulas V-1-1 to V-1-17, and/or one or more compounds represented by Formulas V-2-2 and V-2-4, and necessarily comprises a compound represented by Formula VIII-1-1.

The liquid crystal composition of the present invention preferably comprises one or more compounds represented by Formulas I-1-2, I-1-3, and I-1-11, wherein the mass content of each of the compounds represented by Formulas I-1-2, I-1-3, and I-1-11 is 3-7%; one or more compounds represented by Formula II-1-2, II-1-3, and II-1-4, wherein the mass content of each of the compounds represented by Formulas II-1-2, II-1-3, and II-1-4 is 2-5%; one or more compounds represented by Formulas V-1-2, V-1-3, V-1-4, V-1-8, V-1-14, V-1-15, and V-1-16, wherein the mass content of each of the compounds represented by Formulas V-1-2, V-1-3, V-1-4, V-1-8, V-1-14, V-1-15, and V-1-16 is 5-10%; and one or more compounds represented by Formula V-2-2 and V-2-4, wherein the mass content of each of the compounds represented by Formulas V-2-2 and V-2-4 is 3-10%; and necessarily comprises 30-45% of a compound represented by Formula VIII-1-1. The liquid crystal composition of the present invention has higher optical anisotropy, namely 0.14-0.22, lower rotational viscosity, and higher dielectric anisotropy to meet the requirement of low power consumption, is mainly applied to a working environment of −10° C. to 60° C., and is especially suitable for virtual reality (VR) displays.

The liquid crystal composition of the present invention preferably comprises one or more compounds represented by Formulas I-1 and I-2, one or more compounds represented by Formula II-1, one or more compounds represented by Formulas V-1-1 to V-1-13, and/or one or more compounds represented by Formulas V-2-2 and V-2-4, and necessarily comprises a compound represented by Formula VIII-1-1 and a compound represented by Formula VIII-1-2.

The liquid crystal composition of the present invention preferably comprises one or more compounds represented by Formulas I-1-2, I-1-3, and I-1-11, wherein the mass content of each of the compounds represented by Formulas I-1-2, I-1-3, and I-1-11 is 3-7%; one or more compounds represented by Formulas II-1-2, II-1-3, and II-1-4, wherein the mass content of each of the compounds represented by Formulas II-1-2, II-1-3, and II-1-4 is 2-5%; one or more compounds represented by Formulas V-1-14, V-1-15, and V-1-16, wherein the mass content of each of the compounds represented by Formulas V-1-14, V-1-15, and V-1-16 is 5-16%; and one or more compounds represented by Formulas V-2-2 and V-2-4, wherein the mass content of each of the compounds represented by Formulas V-2-2 and V-2-4 is 5-10%; and necessarily comprises 35-50% by mass of a compound represented by Formula VIII-1-1 and 2-10% by mass of a compound represented by Formula VIII-1-2. The liquid crystal composition of the present invention has suitable optical anisotropy, which is 0.095-0.140, and lower rotational viscosity, is mainly applied to a working environment of −20° C. to 60° C., especially for MNT and TV display devices.

The liquid crystal composition of the present invention preferably comprises one or more compounds represented by Formulas I-1 and I-2, one or more compounds represented by Formula II-1, one or more compounds represented by Formula IV-2, one or more compounds represented by Formulas V-1-1 to V-1-13, and/or one or more compounds represented by Formulas V-2-2 and V-2-4, and necessarily comprises a compound represented by Formula VIII-1-1 and a compound represented by Formula VIII-1-2.

The liquid crystal composition of the present invention preferably comprises one or more compounds represented by Formulas I-1-2, I-1-3, and I-1-11, wherein the mass content of each of the compounds represented by Formulas I-1-2, I-1-3, and I-1-11 is 3-7%; one or more compounds represented by Formulas II-1-2, II-1-3, and II-1-4, wherein the mass content of each of the compounds represented by Formulas II-1-2, II-1-3, and II-1-4 is 2-5%; one or more compounds represented by Formulas IV-2-4, IV-2-5, IV-2-7, IV-2-8, and IV-2-9, wherein the mass content of each of the compounds represented by Formulas IV-2-4, IV-2-5, IV-2-7, IV-2-8, and IV-2-9 is 2-8%; one or more compounds represented by Formulas V-1-14, V-1-15, and V-1-16, wherein the mass content of each of the compounds represented by Formulas V-1-14, V-1-15, and V-1-16 is 5-16%; and one or more compounds represented by Formulas V-2-2 and V-2-4, wherein the mass content of each of the compounds represented by Formulas V-2-2 and V-2-4 is 5-10%; and necessarily comprises 35-48% by mass of a compound represented by Formula VIII-1-1 and 2-10% by mass of a compound represented by Formula VIII-1-2. The liquid crystal composition of the present invention has lower rotational viscosity and larger elastic constant, is mainly applied to the field of fast response display, and is especially suitable for gaming MNT display devices.

The liquid crystal composition of the present invention preferably comprises one or more compounds represented by Formulas I-1 and I-2, one or more compounds represented by Formula II-1, one or more compounds represented by Formula IV-2, one or more compounds represented by Formulas V-1-1 to V-1-13, and/or one or more compounds represented by Formulas V-2-2 and V-2-4, and one or more compounds represented by Formulas VI-1 to VI-5, and necessarily comprises a compound represented by Formula VIII-1-1 and a compound represented by Formula VIII-1-2.

The liquid crystal composition of the present invention preferably comprises one or more compounds represented by Formulas I-1-2, I-1-3, and I-1-11, wherein the mass content of each of the compounds represented by Formulas I-1-2, I-1-3, and I-1-11 is 3-7%; one or more compounds represented by Formulas II-1-2, II-1-3, and II-1-4, wherein the mass content of each of the compounds represented by Formulas II-1-2, II-1-3, and II-1-4 is 2-5%; one or more compounds represented by Formulas IV-2-4, IV-2-5, IV-2-7, IV-2-8, and IV-2-9, wherein the mass content of each of the compounds represented by Formulas IV-2-4, IV-2-5, IV-2-7, IV-2-8, and IV-2-9 is 2-8%; one or more compounds represented by Formulas V-1-14, V-1-15, and V-1-16, wherein the mass content of each of the compounds represented by Formulas V-1-14, V-1-15, and V-1-16 is 5-16%; one or more compounds represented by Formulas V-2-2 and V-2-4, wherein the mass content of each of the compounds represented by Formulas V-2-2 and V-2-4 is 5-10%; and one or more compounds represented by Formulas VI-1 to VI-5, wherein the mass content of each of the compounds represented by Formulas VI-1 to VI-5 is 2-7%; and necessarily comprises 37-48% by mass of a compound represented by Formula VIII-1-1 and 2-10% by mass of a compound represented by Formula VIII-1-2. The liquid crystal composition of the present invention has lower rotational viscosity, higher elastic constant, good flexoelectric effect and less flicker, is mainly applied to the field of broadband display, and is especially suitable for gaming NB display devices.

Other additives, such as UV stabilizers, antioxidants, and free radical scavengers, can also be added to the liquid crystal composition of the present invention. The following additives can be listed:

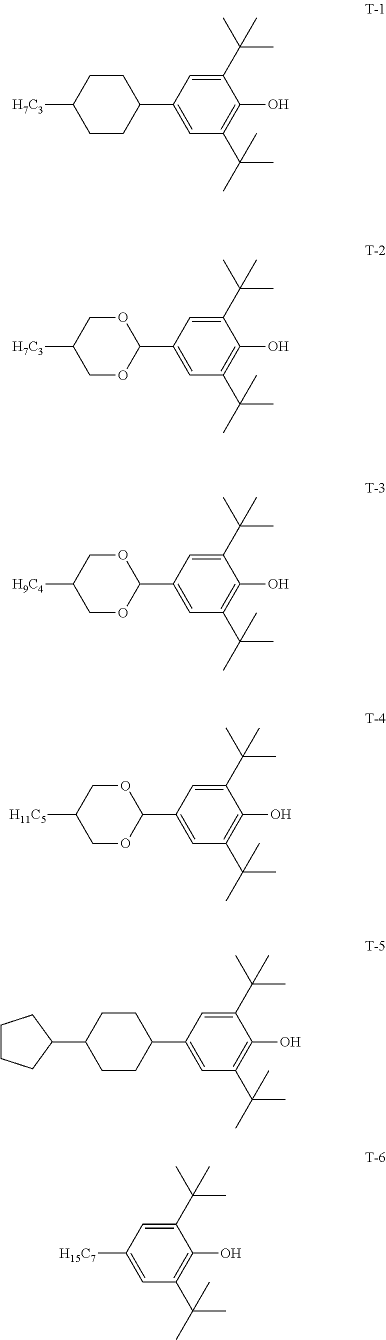

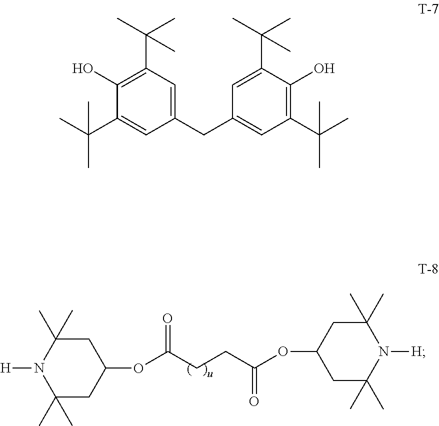

wherein u represents alkylene with a carbon atom number of 1-20.

### [Liquid Crystal Display Element or Liquid Crystal Display]

The present invention further provides a liquid crystal display element or liquid crystal display comprising the above liquid crystal compound or liquid crystal composition.

Preferably, the above liquid crystal display element can be an active matrix addressed liquid crystal display element or a liquid crystal display.

Preferably, the active matrix addressed liquid crystal display element is a VA-TFT, FFS-TFT, or IPS-TFT liquid crystal display element.

The liquid crystal display element or liquid crystal display of the present invention comprises the liquid crystal compound and liquid crystal composition of the present invention and can be used for developing liquid crystal display elements or liquid crystal displays with good reliability and wider working temperature range.

### EXAMPLES

In order to explain the present invention more clearly, the present invention will be further explained below in conjunction with preferred composition examples. A person skilled in the art should understand that the following detailed description is illustrative rather than restrictive, and should not limit the scope of protection of the present invention.

In the present invention, the preparation methods are all conventional methods unless otherwise specified, and the raw materials used can all be obtained from open commercial channels unless otherwise specified. The percentages all refer to mass percentages, and the temperatures are in degrees Celsius (C). Liquid crystal compounds are also referred to as liquid crystal monomers. The specific meanings and test conditions of other symbols are as follows:

Cp represents the clear point (C) of a liquid crystal, as measured by a DSC quantitative method.

S-N represents the melting point (C) from crystalline state to nematic phase of a liquid crystal.

Δn represents optical anisotropy, and Δn=nₑ−nₒ, wherein no is the refractive index of ordinary light, and ne is the refractive index of extraordinary light. The test conditions are 25±2° C., 589 nm, and Abbe refractometer test.

Δε represents dielectric anisotropy, and Δε=ε_{//}/ε_{⊥, wherein Σ}_{//} is the dielectric constant parallel to the molecular axis, and ε⊥ is the dielectric constant perpendicular to the molecular axis. The test conditions are 25±0.5° C., a 20 μm parallel cell, and INSTEC: ALCT-IR1 test.

γ₁ represents rotational viscosity (mPa's), and the test conditions are 25±0.5° C., a 20 μm perpendicular cell, and INSTEC: ALCT-IR1 test.

K₁₁ is the splay elastic constant, K₃₃ is the bend elastic constant, and K₂₂ is the twist elastic constant. The test conditions are 25-2° C., INSTEC: ALCT-IR1, and a 20 μm perpendicular cell.

Flexo is represented by V100 flicker. The test conditions are 25±0.5° C. and an FFS test cell. The test equipment is DMS-501. The unit is expressed in dB. The smaller the value, the better the flexural effect, the smaller the flicker, and the better improved the image retention.

Image retention: The image retention of a liquid crystal display device means that after a specified fixed pattern is displayed in a display area for 1000 hours, the residual level of the inherent pattern during full-screen uniform display is visually evaluated and graded into the following 4 levels:
⊚ no retention; ☆ extremely slight retention, in an acceptable level; Δ retention, in an unacceptable level; and × retention, quite significant.

A method for preparing the liquid crystal composition involves: weighing liquid crystal monomers at a certain ratio, then putting these liquid crystal monomers into a stainless steel beaker, and placing the stainless steel beaker filled with these liquid crystal monomers onto a magnetic stirring instrument for heating and melting; and after most of the liquid crystal monomers in the stainless steel beaker are melted, adding a magnetic rotor to the stainless steel beaker, uniformly stirring the mixture, and cooling the mixture to room temperature to obtain the liquid crystal composition.

The structures of the liquid crystal monomers in the examples of the present invention are represented by codes, and the code representation methods for liquid crystal ring structures, end groups and linker groups are shown in Tables 1 and 2 below.

TABLE 1
Corresponding codes of ring structures

| Ring structure | Corresponding code |
|---|---|
| 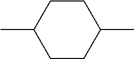 | C |
| 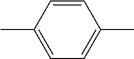 | P |
| 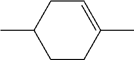 | L |
| 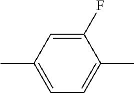 | G |
| 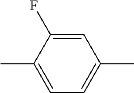 | Gi |
| 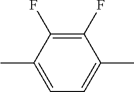 | Y |
| 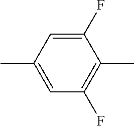 | U |
| 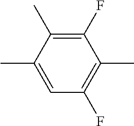 | K |
| 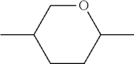 | A |
| 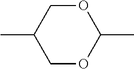 | D |
| 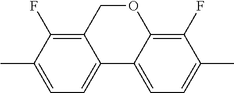 | Sa |
| 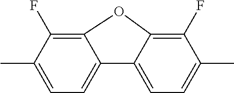 | Sb |
| 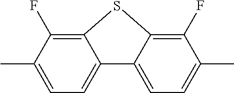 | Sc |

TABLE 2
Corresponding codes of end groups and linker groups

| End groups and linker groups | Corresponding code |
|---|---|
| CₙH₂ₙ₊₁— | n- |
| CₙH₂ₙ₊₁O— | nO— |
| —CF₃ | —T |
| —OCF₃ | —OT |
| —CF₂O— | —Q— |
| —CH₂O— | —O— |
| —O— | —B— |
| —F | —F |
| —CN | —CN |
| —CH₂CH₂— | —E— |
| —CH═CH— | —V— |
| —C≡C— | —W— |
| —COO— | —Z— |
| —CH═CH—CₙH₂ₙ₊₁ | —Vn |
| 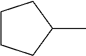 | Cp- |
| 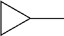 | Cpr- |
| 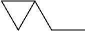 | Cpr1- |

By way of example:

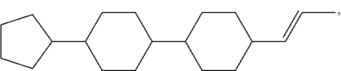 [SMILES: C/C=C/C1CCC(C2CCC(C3CCCC3)CC2)CC1]

with code CC-Cp-V1;

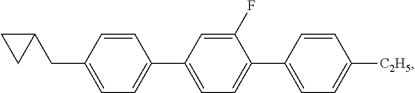 [SMILES: CCc1ccc(-c2ccc(-c3ccc(CC4CC4)cc3)cc2F)cc1]

with code PGP-Cpr1-2;

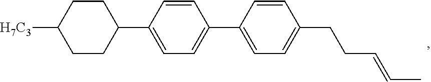

with code CPP-3-2V1;

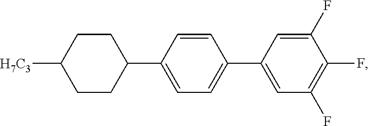

with code CPU-3 —F;

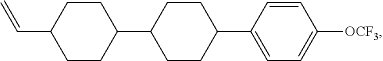 [SMILES: C=CC1CCC(C2CCC(c3ccc(OC(F)(F)F)cc3)CC2)CC1]

with code CCP-V-OT;

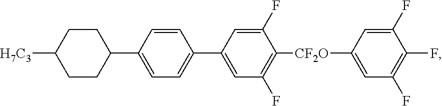

with code CPUQU-3 —F;

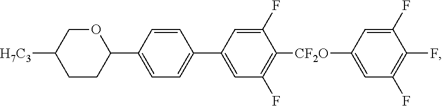

with code APUQU-3 —F;

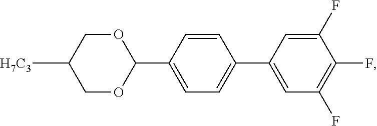

with code DPU-3 —F.

Data of liquid crystal composition examples and comparative examples:

TABLE 3

| Structural | Example | Example | Comparative | Comparative |
|---|---|---|---|---|
| formula | 1 | 2 | Example 1 | Example 2 |
| CCG-2-F | | | | 20 |
| CPG-3-F | | | | 20 |
| CCP-3-1 | 10 | | 7 | |
| CPP-3-F | | | | 10 |
| CCG-V-F | | | | 10 |
| CCP-V-1 | 10 | 6 | 10 | |
| CC-3-V | 47 | 48 | 47 | 20 |
| CC-3-V1 | 5 | 5 | 5 | 5 |
| PGU-2-F | | | 5 | |
| PGP-2-2V | 5 | 4 | 11 | 0 |
| PGUQU-3-F | 5 | 2 | | |
| APUQU-3-F | 5 | | 5 | |
| CDUQU-3-F | 5 | 8 | 5 | |
| PP-1-2V | 5 | 7 | | 10 |
| DPUQU-4-F | | 5 | | |
| CPUQU-3-F | | | 5 | |
| CCVC-3-V | | 8 | | 5 |
| I-1-3 | 3 | 4 | | |
| I-1-11 | | 3 | | |
| Cp | 84.4 | 86.4 | 85.8 | 83.5 |
| Δn | 0.0996 | 0.1009 | 0.1003 | 0.1009 |
| Δε | 4.27 | 4.22 | 4.21 | 4.27 |
| γ₁ | 46.3 | 41.1 | 49.0 | 73.8 |
| K₁₁ | 13.4 | 13.9 | 12.8 | 11.8 |
| K₃₃ | 15.7 | 15.0 | 15.6 | 15.1 |
| γ₁/K₁₁ | 3.46 | 2.96 | 3.84 | 6.26 |
| Image retention | ☆ | ☆ | Δ | X |
| Flicker (V100, | −50 | −58 | −37 | −25 |
| dB) | | | | |

On the basis of Examples 1 and 2 of the present invention and Comparative Examples 1 and 2 maintaining suitable clear point, suitable optical anisotropy and appropriate dielectric anisotropy, the liquid crystal composition examples 1 and 2 of the present invention have smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for MNT and TV applications with a display panel cell thickness of 3.3-3.7 μm and a response time within 10 ms.

TABLE 4

| Structural | Example | Example | Comparative | Comparative |
|---|---|---|---|---|
| formula | 3 | 4 | Example 3 | Example 4 |
| CCP-V-1 | 10 | 11 | 5 | 11 |
| CC-3-V | 41 | 46 | 40 | 45 |
| CC-3-V1 | 7 | 6 | 12 | 2 |
| PGP-2-2V | 9 | | 10 | |
| PGP-1-2V | | 5 | 8 | 11 |
| PGP-3-2V | | | | 6 |
| PGUQU-3-F | 5 | 5 | 5 | |
| PGUQU-4-F | 5 | | 5 | |
| PP-1-2V1 | | 9 | | 10 |
| APUQU-3-F | 5 | | 5 | |
| APUQU-2-F | | 5 | | 5 |
| CDUQU-3-F | 5 | | 5 | |
| PP-1-2V | 5 | | 5 | |
| CPUQU-3-F | | | | 5 |
| DGUQU-3-F | | 5 | | 5 |
| I-1-3 | 4 | 2 | | |
| I-1-2 | | 4 | | |
| I-1-11 | 4 | 2 | | |
| Cp | 83.1 | 78.9 | 81.9 | 79.9 |
| Δn | 0.1194 | 0.1206 | 0.1201 | 0.1208 |
| Δε | 5.75 | 5.55 | 5.07 | 3.86 |
| γ₁ | 47.9 | 45.0 | 49.8 | 51.0 |
| K₁₁ | 13.8 | 14.1 | 13.5 | 13.2 |
| K₃₃ | 15.2 | 15.2 | 15.3 | 15.6 |
| γ₁/K₁₁ | 3.47 | 3.20 | 3.69 | 3.87 |
| Image retention | ☆ | ☆ | Δ | X |
| Flicker (V100, | −51 | −59 | −39 | −30 |
| dB) | | | | |

On the basis of Examples 3 and 4 of the present invention and Comparative Examples 3 and 4 maintaining suitable clear point and suitable optical anisotropy, the liquid crystal composition examples 3 and 4 of the present invention have larger dielectric anisotropy and smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for MNT and TV applications with a display panel cell thickness of 2.6-3.2 μm and a response time within 10 ms.

TABLE 5

| Structural | Example | Example | Comparative | Comparative |
|---|---|---|---|---|
| formula | 5 | 6 | Example 5 | Example 6 |
| CP-5-F | | | | 5 |
| CCG-2-F | | | | 5 |
| CPG-2-F | | | | 5 |
| CPG-3-F | | | | 10 |
| CCG-V-F | | | | 5 |
| CC-3-V | 44 | 45 | 41 | 29 |
| CC-3-V1 | 7 | 4 | | |
| PGP-2-2V | 8 | 15 | 8 | 11 |
| PGP-1-2V | | | 12 | 12 |
| PGUQU-3-F | 5 | | 5 | |
| PGUQU-4-F | 5 | | 5 | |
| PP-1-2V1 | | | 5 | 11 |
| APUQU-3-F | 5 | 5 | 5 | |
| APUQU-Cp-F | | 3 | | |
| CDUQU-3-F | 5 | 5 | 5 | |
| PP-1-2V | 7 | 5 | 7 | |
| CPUQU-3-F | | 5 | | |
| CPP-3-1 | | | 7 | 7 |
| DGUQU-3-F | | 5 | | |
| I-1-3 | 7 | 4 | | |
| I-1-2 | 5 | 2 | | |
| I-1-11 | 2 | 2 | | |
| Cp | 81.5 | 82.3 | 80.9 | 80.5 |
| Δn | 0.1398 | 0.1301 | 0.1400 | 0.1401 |
| Δε | 7.22 | 7.06 | 5.34 | 2.54 |
| γ₁ | 45.7 | 51.0 | 55.3 | 58.8 |
| K₁₁ | 15 | 14 | 14.1 | 13.7 |
| K₃₃ | 14.3 | 14.6 | 14.9 | 14.4 |
| γ₁/K₁₁ | 3.05 | 3.65 | 3.93 | 4.29 |
| Image retention | ☆ | ☆ | Δ | X |
| Flicker (V100, | −50 | −51 | −35 | −22 |
| dB | | | | |

On the basis of Examples 5 and 6 of the present invention and Comparative Examples 5 and 6 maintaining suitable clear point and suitable optical anisotropy, the liquid crystal composition examples 5 and 6 of the present invention have larger dielectric anisotropy and smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for MNT applications with a display panel cell thickness of 2.5-3.0 μm and a response time within 8 ms.

TABLE 6

| Structural | Example | Example | Comparative | Comparative |
|---|---|---|---|---|
| formula | 7 | 8 | Example 7 | Example 8 |
| CCP-3-1 | | | 3 | 6 |
| CCP-V-1 | | | 5 | |
| CC-3-V | 47 | 41 | 37.5 | 38.5 |
| CC-3-V1 | 5 | 10 | 10 | 10 |
| PGP-3-2 | | | 6.5 | 8.5 |
| PGP-2-2V | 10 | 11 | 12 | 12 |
| PGP-3-2V | | | 2 | |
| PGUQU-3-F | 5 | | 5 | 5 |
| PGUQU-4-F | | | 5 | 5 |
| PP-1-2V1 | 3 | 5 | 4 | 5 |
| APUQU-3-F | 5 | 5 | 5 | 5 |
| CDUQU-3-F | 5 | 5 | 5 | 5 |
| CLP-V-1 | 2 | | | |
| CLP-3-T | 5 | | | |
| DPUQU-4-F | | 5 | | |
| CLP-3-OT | | 2 | | |
| CLP-V-OT | | 2 | | |
| CLP-3-1 | 3 | 2 | | |
| CLP-3-2 | | 2 | | |
| I-1-3 | 3 | 5 | | |
| I-1-2 | 3 | 5 | | |
| I-1-11 | 4 | | | |
| Cp | 88.8 | 87.7 | 87.2 | 84.9 |
| Δn | 0.1276 | 0.1277 | 0.1256 | 0.1254 |
| Δε | 5.99 | 5.94 | 5.13 | 5.20 |
| γ₁ | 50.5 | 46.3 | 53.6 | 51.6 |
| K₁₁ | 16.5 | 16.5 | 14.4 | 14.2 |
| K₃₃ | 16.1 | 16.1 | 15.5 | 14.9 |
| γ₁/K₁₁ | 3.06 | 2.81 | 3.72 | 3.65 |
| Image retention | ⊚ | ⊚ | Δ | X |
| Flicker (V100, | −52 | −58 | −30 | −28 |
| dB) | | | | |

On the basis of Examples 7 and 8 of the present invention and Comparative Examples 7 and 8 maintaining suitable optical anisotropy, the liquid crystal composition examples 7 and 8 of the present invention have larger dielectric anisotropy and smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for MNT gaming applications with a display panel cell thickness of 2.5-3.0 μm and a response time within 5 ms.

TABLE 7

| Structural | Example | Example | Comparative | Comparative |
|---|---|---|---|---|
| formula | 9 | 10 | Example 9 | Example 10 |
| CC-3-V | 47 | 44 | 45 | 38 |
| CC-3-V1 | 5 | 5 | | 5 |
| PGP-3-2 | 5 | 8 | 5 | 8 |
| PGU-2-F | | | | 10 |
| PGU-3-F | | | | 5 |
| PGP-2-2V | | | 15 | |
| PGUQU-3-F | 5 | | | |
| PP-1-2V1 | 3 | 2 | | 3 |
| APUQU-3-F | 5 | 5 | 5 | 5 |
| APUQU-2-F | | | 5 | |
| CDUQU-3-F | 5 | 6 | 8 | 6 |
| CPUP-3-OT | | | 5 | 8 |
| CLP-V-1 | 5 | 4 | | 7 |
| CLP-3-1 | | 3 | | |
| PP-1-2V | | | 2 | |
| CLP-V-OT | 5 | 5 | 5 | 5 |
| PGU-3-T | 5 | 10 | 5 | |
| I-1-3 | 4 | 4 | | |
| I-1-2 | 3 | 4 | | |
| I-1-11 | 3 | | | |
| Cp | 83.2 | 83.8 | 84.3 | 85.4 |
| An | 0.1244 | 0.1255 | 0.1245 | 0.1244 |
| Δε | 7.50 | 7.31 | 6.67 | 6.77 |
| γ₁ | 45.9 | 46.6 | 51.5 | 55.9 |
| K₁₁ | 15.7 | 16.3 | 14 | 14.5 |
| K₃₃ | 15.1 | 14.8 | 14.5 | 14.9 |
| γ₁/K₁₁ | 2.93 | 2.87 | 3.67 | 3.85 |
| Image retention | ⊚ | ⊚ | Δ | X |
| Flicker (V100, | −56 | −58 | −33 | −22 |
| dB) | | | | |

On the basis of Examples 9 and 10 of the present invention and Comparative Examples 9 and 10 maintaining suitable clear point, suitable optical anisotropy and appropriate dielectric anisotropy, the liquid crystal composition examples 9 and 10 of the present invention have smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for NB gaming applications with a display panel cell thickness of 2.5-3.0 μm and a response time within 5 ms.

TABLE 8

| Structural | | | | Comparative | Comparative | Comparative |
|---|---|---|---|---|---|---|
| formula | Example 11 | Example 12 | Example 13 | Example 11 | Example 12 | Example 13 |
| CCG-2-F | | | | | 9 | 9 |
| CPG-3-F | | | | | 10 | 15 |
| CPG-5-F | | | | | 13 | 19 |
| PP-5-1 | | | | | 11.5 | 15.5 |
| CCPG-3-F | | | | | 0 | 0 |
| CPP-3-F | | | | | 10 | 5 |
| CCG-V-F | | | | | 10 | 10 |
| CCP-V-1 | 5 | 3 | 5.5 | | | |
| CC-3-V | 45 | 38.5 | 37 | 45 | 20.5 | 11 |
| CC-3-V1 | 5.5 | 8.5 | 10 | | | |
| PGP-3-2 | | 5 | 5 | | | |
| PGP-5-2 | | | 6 | | | |
| PGP-2-2V | 10 | 10 | 6 | 11 | | 10 |
| PGP-1-2V | 1 | | | 4 | | |
| PGP-3-2V | | 4 | | | | |
| PGUQU-3-F | 6 | | 6 | 6 | | |
| PGUQU-4-F | 5 | | 7 | 6 | | |
| PP-1-2V1 | 8 | 2.5 | 9 | 10 | 6 | 5.5 |
| PPGU-Cp-F | 0.5 | 0.5 | 0.5 | 0.5 | | |
| CDUQU-3-F | | 4 | | | | |
| CPUP-3-OT | | | | 8 | | |
| PP-1-2V | 4 | 10 | 4 | 5.5 | | |
| CPP-3-1 | | | | 4 | | |
| I-1-3 | 10 | 5 | 4 | | 10 | |
| APUQU-3-F | | 5 | | | | |
| DGUQU-3-F | | 4 | | | | |
| Cp | 77.2 | 76.6 | 76.7 | 77.9 | 80.2 | 75.6 |
| Δn | 0.1396 | 0.139 | 0.139 | 0.1391 | 0.1397 | 0.1387 |
| Δε | 4.53 | 4.25 | 4.00 | 4.20 | 5.08 | 4.46 |
| γ₁ | 41.1 | 43.9 | 44.2 | 47.7 | 71.0 | 84.2 |
| K₁₁ | 14.5 | 14.1 | 14.6 | 13.4 | 14.5 | 13.5 |
| K₃₃ | 13.9 | 13.7 | 13.5 | 14 | 14.6 | 14.1 |
| γ₁/K₁₁ | 2.84 | 3.12 | 3.03 | 3.56 | 4.91 | 6.24 |
| Image | ⊚ | ⊚ | ⊚ | Δ | X | X |
| retention | | | | | | |
| Flicker | −55 | −51 | −52 | −40 | −25 | −20 |
| (V100, | | | | | | |
| dB) | | | | | | |

On the basis of Examples 11, 12 and 13 of the present invention and Comparative Examples 11, 12 and 13 maintaining suitable clear point and suitable optical anisotropy, the liquid crystal composition examples 11, 12 and 13 of the present invention have smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for VR applications with a display panel cell thickness of 1.5-1.8 μm and a response time within 3 ms.

TABLE 9

| Structural | | | | Comparative | Comparative | Comparative |
|---|---|---|---|---|---|---|
| formula | Example 14 | Example 15 | Example 16 | Example 14 | Example 15 | Example 16 |
| CC-3-V | 45 | 31 | 35 | 33.5 | 19.5 | 11 |
| CC-3-V1 | 5.5 | 8.5 | 5 | | | |
| CCG-2-F | | | | | 9 | |
| CCG-V-F | | | | | 3 | 10 |
| CCP-V-1 | 5 | 3 | 5.5 | | | |
| CDUQU-3-F | | 4 | | | | |
| CPG-3-F | | | | | 10 | 15 |
| CPG-5-F | | | | | 13 | 19 |
| CPP-3-1 | | | | 3 | | |
| CPP-3-F | | | | | 8 | 5 |
| CPUP-3-OT | | | | 8 | | |
| I-1-3 | 10 | 7 | 3 | | 10 | |
| I-1-2 | 7 | 4 | 4 | | | |
| I-1-11 | 3 | 4 | 7 | | | |
| PGP-1-2V | | | | 10 | | |
| PGP-2-2V | | | 1 | 11 | | 11 |
| PGP-3-2 | | 5 | 2 | | | 3 |
| PGP-3-2V | | 4 | | | | |
| PGP-5-2 | | | 6 | | | |
| PGUQU-3-F | 6 | 4 | 6 | 6 | | |
| PGUQU-4-F | 5 | 5 | 7 | 6 | | |
| PP-1-2V | 5 | 10 | 9 | 10 | 4 | 5 |
| PP-1-2V1 | 8 | 10 | 9 | 9 | 6 | |
| PP-5-1 | | | | 3 | 11.5 | 15.5 |
| PPGU-Cp-F | 0.5 | 0.5 | 0.5 | 0.5 | | |
| UWPP-2-3 | | | | | 6 | 5.5 |
| Cp | 78.0 | 78.9 | 78.5 | 79.3 | 80.1 | 81.3 |
| Δn | 0.1617 | 0.1608 | 0.1592 | 0.1598 | 0.1593 | 0.1609 |
| Δε | 5.74 | 5.75 | 5.69 | 4.48 | 4.79 | 3.36 |
| γ₁ | 41.9 | 47.1 | 45.3 | 54.7 | 69.0 | 76.4 |
| K₁₁ | 15.9 | 16.5 | 16.0 | 14.3 | 15.8 | 15.2 |
| K₃₃ | 13.6 | 14.4 | 13.5 | 14.2 | 14.2 | 14 |
| γ₁/K₁₁ | 2.64 | 2.84 | 2.83 | 3.83 | 4.38 | 5.03 |
| Image | ⊚ | ⊚ | ⊚ | Δ | X | X |
| retention | | | | | | |
| Flicker | −51 | −55 | −57 | −40 | −28 | −21 |
| (V100, | | | | | | |
| dB) | | | | | | |

On the basis of Examples14, 15 and 16 of the present invention and Comparative Examples 14, 15 and 16 maintaining suitable clear point and suitable optical anisotropy, the liquid crystal composition examples 14, 15 and 16 of the present invention have smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for VR applications with a display panel cell thickness of 1.5-1.8 μm and a response time within 3 ms.

TABLE 10

| Structural | | | | Comparative | Comparative | Comparative |
|---|---|---|---|---|---|---|
| formula | Example 17 | Example 18 | Example 19 | Example 17 | Example 18 | Example 19 |
| CCG-2-F | | | | | 9 | |
| CPG-3-F | | | | | 10 | 15 |
| CPG-5-F | | | | | 13 | 19 |
| PP-5-1 | | | | 9 | | 15.5 |
| CPP-3-F | | | | | 8 | 5 |
| CCG-V-F | | | | | | |
| CC-3-V | 30 | 30 | 30 | 20.5 | 14.5 | 5 |
| CC-3-V1 | 5.5 | 3.5 | 5 | | | |
| UTPP-2-3 | | | | | | 5.5 |
| PGP-3-2 | 4 | 6 | 3.5 | | | 9 |
| PGP-5-2 | | | 6 | | | |
| PGP-2-2V | 10 | | 3 | 11 | 16.5 | 11 |
| PGP-1-2V | | | | 10 | | |
| PGP-3-2V | | 6 | | 10 | | |
| PGUQU-3-F | 6 | 4 | 6 | 6 | | |
| PGUQU-4-F | 5 | 5 | 7 | 6 | | |
| PP-1-2V1 | 9 | 10 | 10 | 9 | 6 | |
| CPTP-3-OT | | | | | | 5 |
| APUQU-3-F | | 4 | | | | |
| PPGU-Cp-F | 0.5 | 0.5 | 0.5 | 0.5 | | |
| CPUP-3-OT | | | | 8 | | |
| PP-1-2V | 9 | 10 | 8 | 8 | 7 | 10 |
| CPP-3-1 | | | | 2 | | |
| I-1-3 | 10 | 10 | 7 | | 7 | |
| I-1-2 | 4 | 7 | 7 | | 7 | |
| I-1-11 | 7 | 4 | 7 | | 2 | |
| Cp | 86.4 | 85.1 | 85.8 | 86.0 | 100.2 | 84.7 |
| Δn | 0.1864 | 0.1862 | 0.1861 | 0.1856 | 0.1848 | 0.186 |
| Δε | 6.60 | 6.94 | 7.02 | 4.68 | 5.91 | 3.19 |
| γ₁ | 49.4 | 51.3 | 50.4 | 69.6 | 82.8 | 78.7 |
| K₁₁ | 18.2 | 18.2 | 18.4 | 16.5 | 18.6 | 17.4 |
| K₃₃ | 14.4 | 14.3 | 13.9 | 15.1 | 16.5 | 14.0 |
| γ₁/K₁₁ | 2.72 | 2.82 | 2.74 | 4.21 | 4.44 | 4.52 |
| Image | ⊚ | ⊚ | ⊚ | Δ | X | X |
| retention | | | | | | |
| Flicker | −50 | −55 | −58 | −37 | −25 | −22 |
| (V100, | | | | | | |
| dB) | | | | | | |

On the basis of Examples17, 18 and 19 of the present invention and Comparative Examples 17, 18 and 19 maintaining suitable clear point and suitable optical anisotropy, the liquid crystal composition examples 17, 18 and 19 of the present invention have smaller γ₁/K₁₁ ratios, and therefore, the liquid crystal compositions of the present invention have faster response speed; in addition, the liquid crystal compositions of the present invention have more excellent flicker and image retention levels and can meet the requirements of devices for VR applications with a display panel cell thickness of 1.5-1.8 μm and a response time within 3 ms.

FLICKER is an important index to characterize VRR. The greater the absolute value thereof, the larger the adjustable range of VRR, the better the display performance, and the less likely to cause defects such as tailing and image retention. FLICKER is greatly influenced by the configuration of the liquid crystal. The more the pear-shaped or banana-shaped molecules, the worse the flicker. In the liquid crystal composition of the present invention, the synergistic effect of the compounds represented by Formula I and Formula II or Formula III is beneficial for the conduction and release of free radicals and ions in the liquid crystal composition, thereby improving the image retention level of the liquid crystal composition and finally improving the flicker issue of a liquid crystal display panel. In addition, due to the collocation of molecules in the liquid crystal composition, the liquid crystal molecules in the composition are less affected by an electric field, the deformation effect of the liquid crystal molecules is small, and the flexoelectric performance is excellent, finally improving the flicker level of the liquid crystal display panel and finding its use for the demand of broadband applications. In addition, the liquid crystal composition of the present invention has relatively large elastic constant K₁₁ and relatively small rotational viscosity γ₁ while maintaining suitable optical anisotropy and suitable clear point, that is, the liquid crystal composition of the present invention has a relatively small γ₁/K₁ ratio, so that the liquid crystal display element and the liquid crystal display have a relatively fast response speed.

Apparently, the above examples of the present invention are only provided by way of example for clearly explaining the present invention and are not limitations to the embodiments of the present invention. For those of ordinary skill in the art, other variations or changes in different forms can also be made on the basis of the above description, and it is impossible to exhaust all the embodiments here. All apparent variations or changes derived from the technical solution of the present invention still fall within the scope of protection of the present invention.

1. A liquid crystal composition comprising one or more compounds represented by Formula I and one or more compounds represented by Formula II and/or Formula III, 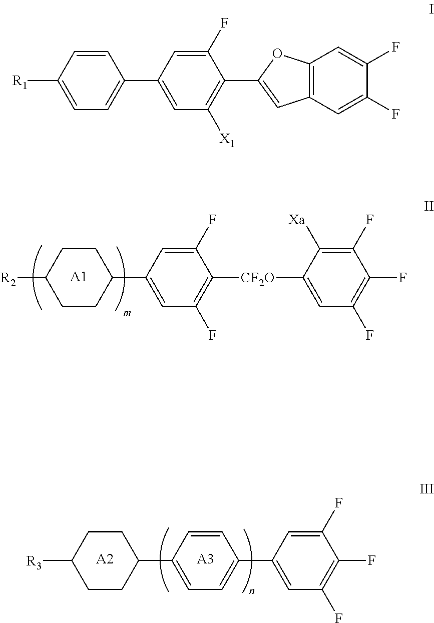
wherein
R₁, R₂, and R₃ each independently represent alkyl with a carbon atom number of 1-15 or alkenyl with a carbon atom number of 2-15; and one or more non-adjacent —CH₂- in R₁ and R₂ are optionally substituted with cyclopentylene or cyclopropylene;
X₁ represents —H or —F;
Xa represents —H or —CH₃; 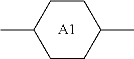
represents 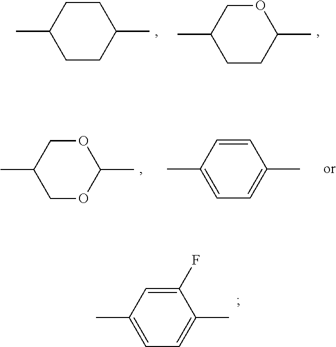 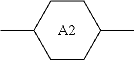
represents 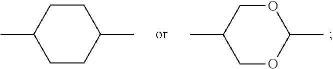 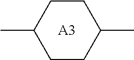
represents 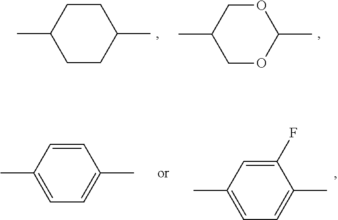
wherein 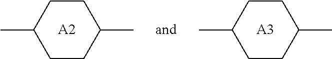
do not both represent 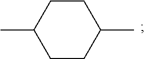
m and n each independently represent 1 or 2;
when m represents 2, two 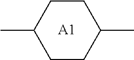
are optionally the same or different; and
when n represents 2, two 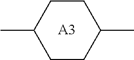
are optionally the same or different, and two 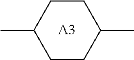
do not both represent

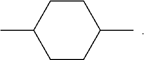

2. The liquid crystal composition according to claim 1, wherein the compound represented by Formula I is selected from the group consisting of compounds represented by the following Formulas I-1 to I-2, 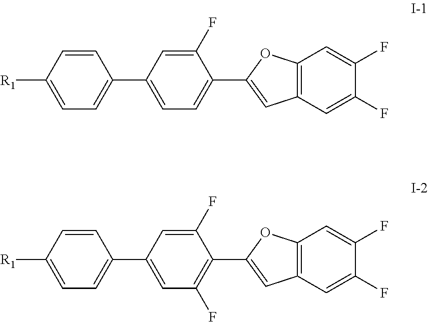
wherein
R₁ represents alkyl with a carbon atom number of 1-15 or alkenyl with a carbon atom number of 2-15; and one or more non-adjacent —CH₂- in R₁ are optionally substituted with cyclopentylene or cyclopropylene.

3. The liquid crystal composition according to claim 1, wherein the compound represented by Formula II is selected from the group consisting of compounds represented by the following Formulas II-1 to II-7, 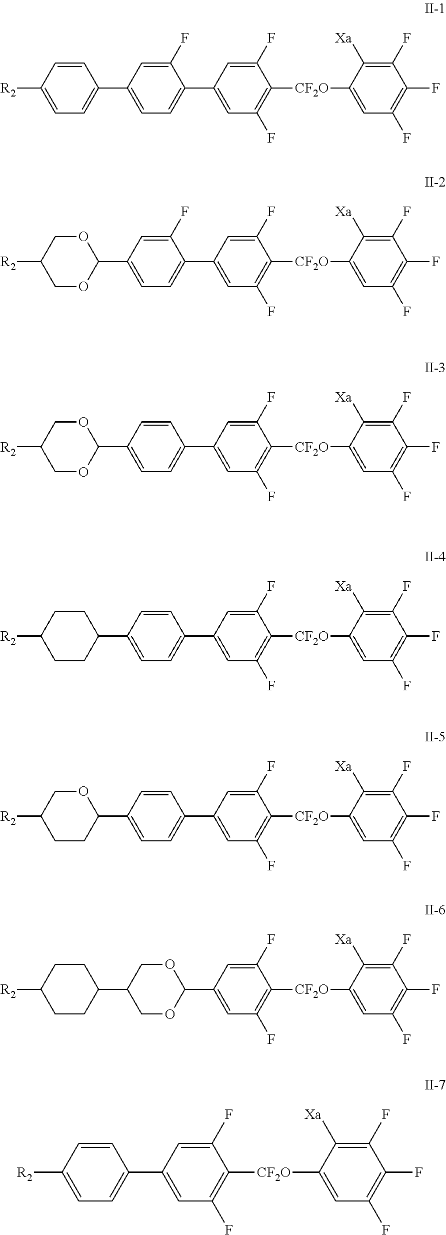
wherein
R₂ represents alkyl with a carbon atom number of 1-15, and one or more non-adjacent-CH₂- in R₂ are optionally substituted with cyclopentylene or cyclopropylene; and
Xa represents —H or —CH₃.

4. The liquid crystal composition according to claim 1, wherein the liquid crystal composition further comprises one or more compounds represented by Formula IV, 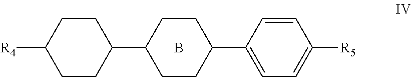
wherein
R₄ represents alkyl with a carbon atom number of 1-15, alkenyl with a carbon atom number of 2-15, or alkoxy with a carbon atom number of 1-15;
R₅ represents alkyl with a carbon atom number of 1-15, alkenyl with a carbon atom number of 2-15, alkoxy with a carbon atom number of 1-15, —F, —CF₃, or —OCF₃; and 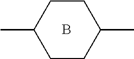
represents

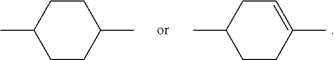

5. The liquid crystal composition according to claim 4, wherein the compound represented by Formula IV is selected from the group consisting of compounds represented by the following Formulas IV-1 to IV-2, 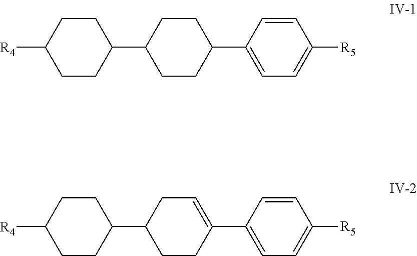
wherein
R₄ represents alkyl with a carbon atom number of 1-15, alkenyl with a carbon atom number of 2-15, or alkoxy with a carbon atom number of 1-15;
R₅ represents alkyl with a carbon atom number of 1-15, alkenyl with a carbon atom number of 2-15, alkoxy with a carbon atom number of 1-15, —F, —CF₃, or —OCF₃.

6. The liquid crystal composition according to claim 5, wherein the compound represented by Formula IV-1 is selected from the group consisting of compounds represented by the following Formulas IV-1-1 to IV-1-13, 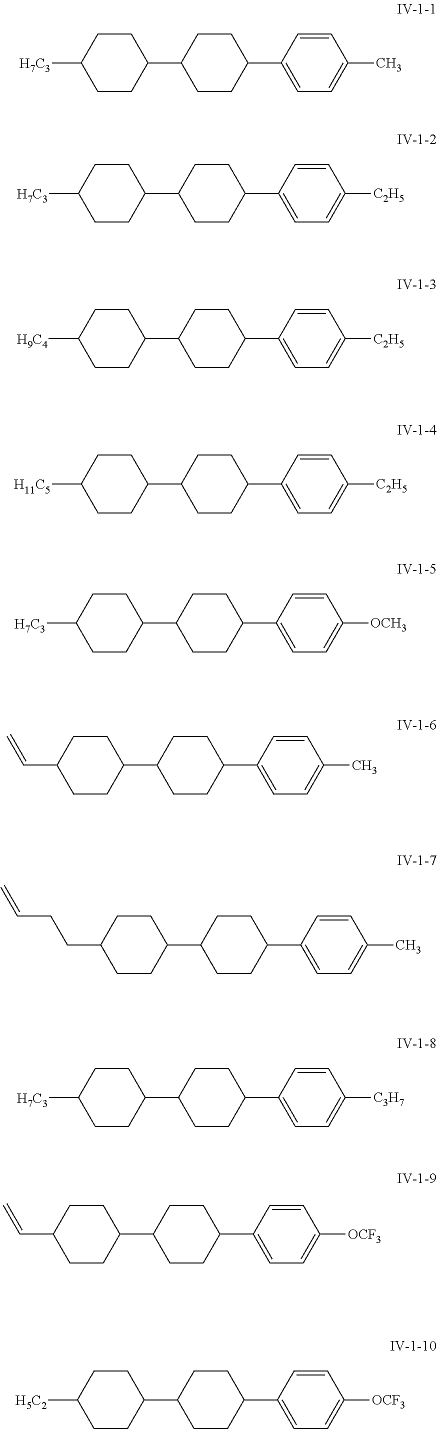 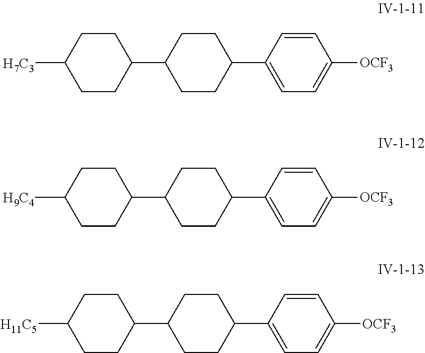
and the compound represented by Formula IV-2 is selected from the group consisting of compounds represented by the following Formulas IV-2-1 to IV-2-16,

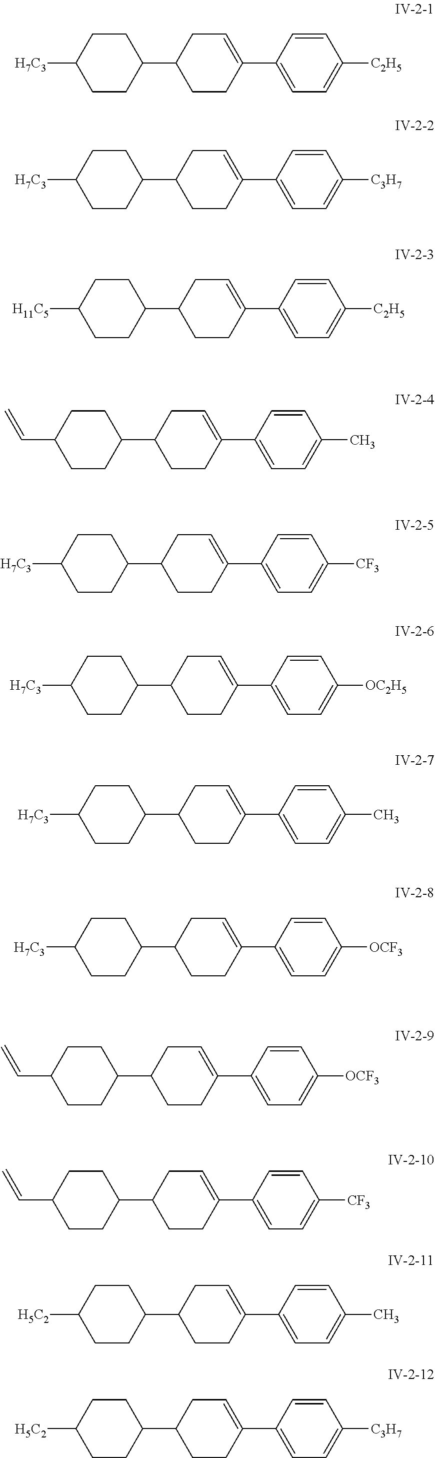

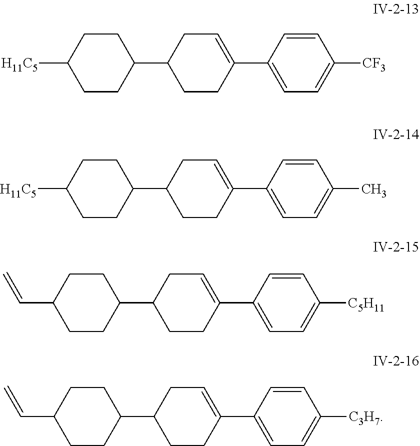

7. The liquid crystal composition according to claim 1, wherein the liquid crystal composition further comprises one or more compounds represented by Formula V, 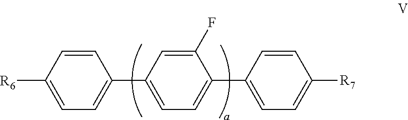
wherein
R₆ represents alkyl with a carbon atom number of 1-15, alkenyl with a carbon atom number of 2-15, or alkoxy with a carbon atom number of 1-15;
R₇ represents alkyl with a carbon atom number of 1-15, alkenyl with a carbon atom number of 2-15, alkoxy with a carbon atom number of 1-15, —F, —CF₃, or —OCF₃; and
a represents 0 or 1.

8. The liquid crystal composition according to claim 7, wherein the compound represented by Formula V is selected from the group consisting of compounds represented by the following Formulas V-1 to V-2, 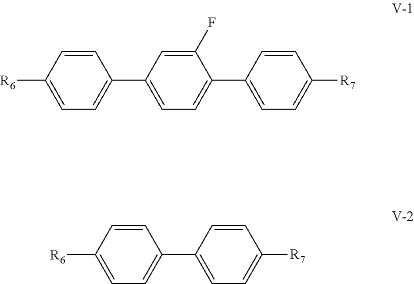
wherein
R₆ represents alkyl with a carbon atom number of 1-15, alkenyl with a carbon atom number of 2-15, or alkoxy with a carbon atom number of 1-15;
R₇ represents alkyl with a carbon atom number of 1-15, alkenyl with a carbon atom number of 2-15, alkoxy with a carbon atom number of 1-15, —F, —CF₃, or —OCF₃.

9. The liquid crystal composition according to claim 8, wherein the compound represented by Formula V-1 is selected from the group consisting of compounds represented by the following Formulas V-1-1 to V-1-31, 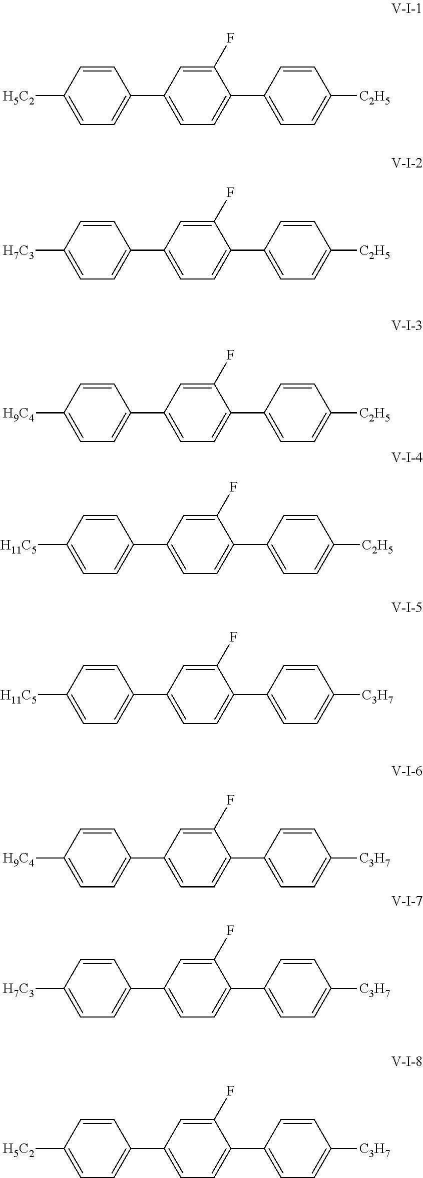 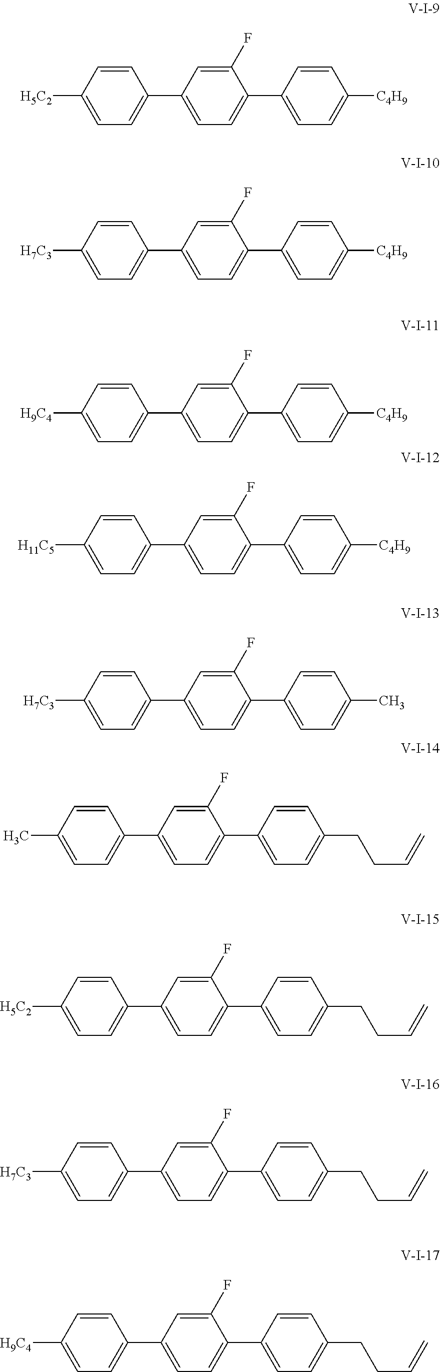 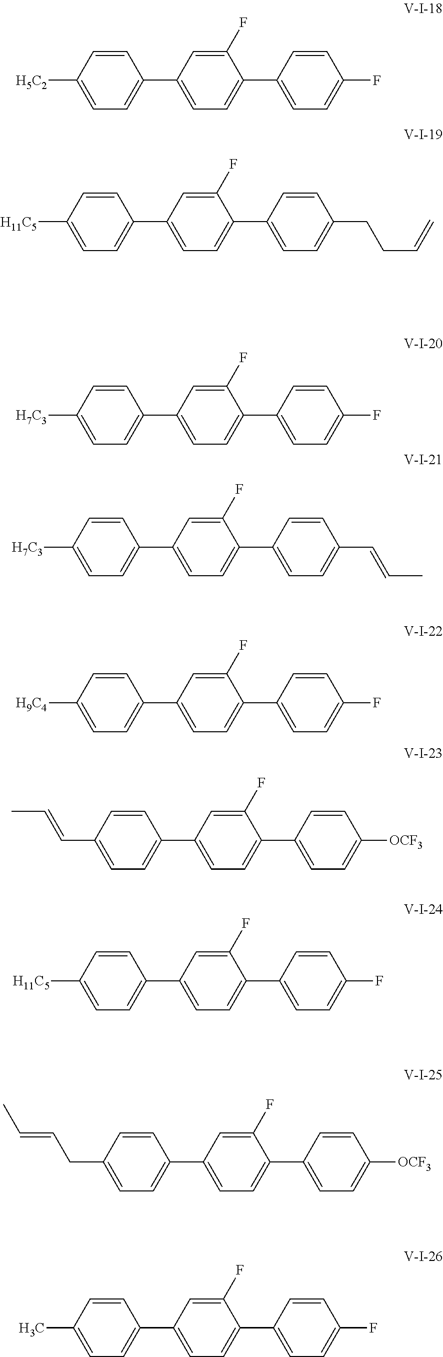 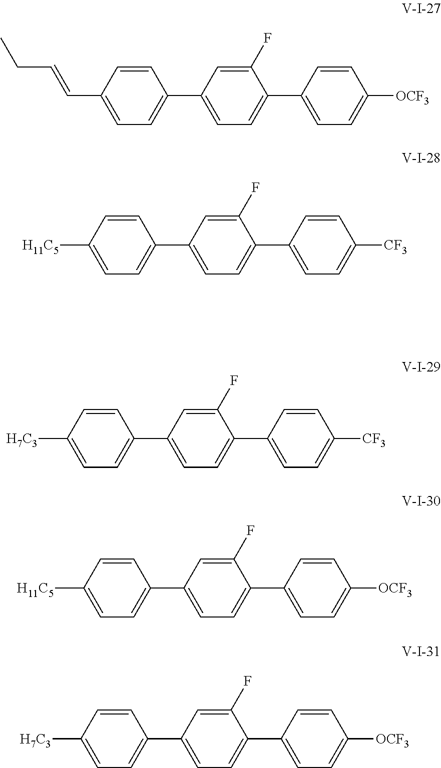
and the compound represented by Formula V-2 is selected from the group consisting of compounds represented by the following Formulas V-2-1 to V-2-6,

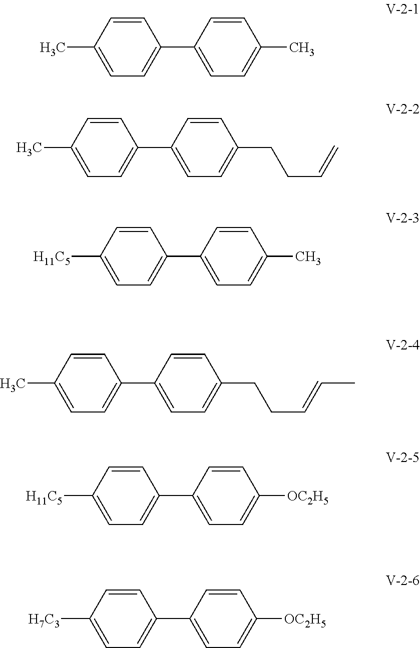

10. The liquid crystal composition according to claim 1, wherein the liquid crystal composition further comprises one or more compounds represented by Formula VI, 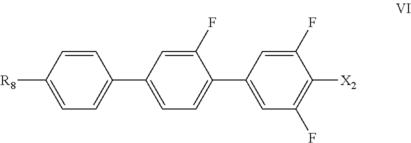
wherein
R₅ represents alkyl with a carbon atom number of 1-15 or alkenyl with a carbon atom number of 2-15; and
X₂ represents —CF₃ or —OCF₃.

11. The liquid crystal composition according to claim 10, wherein the compound represented by Formula VI is selected from the group consisting of compounds represented by the following Formulas VI-1 to VI-10,

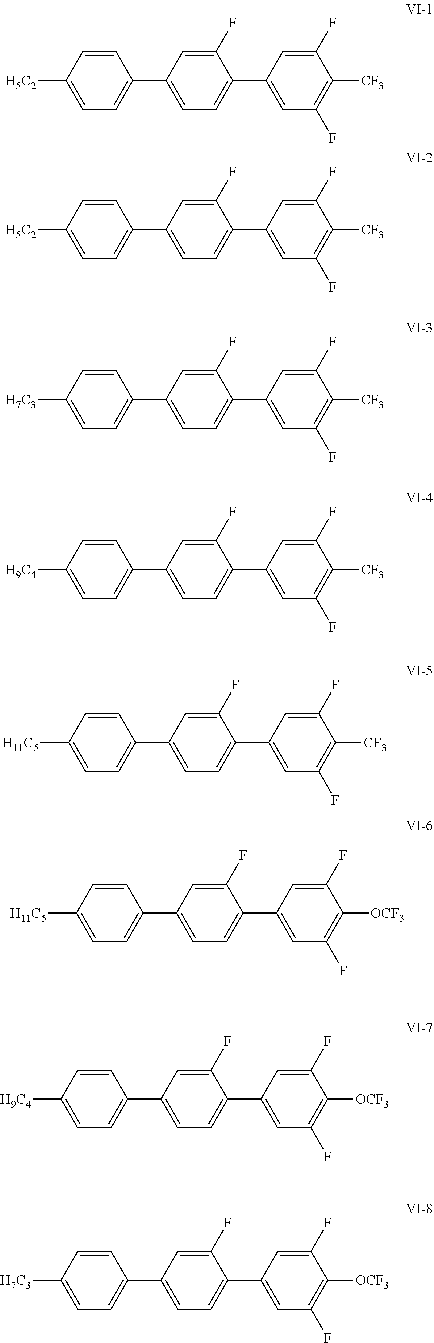

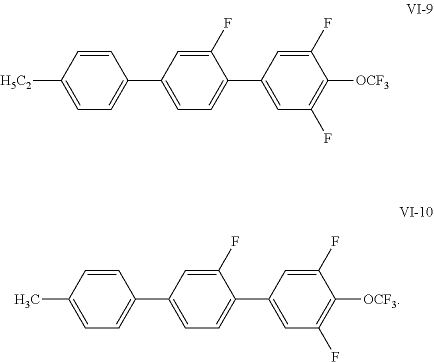

12. The liquid crystal composition according to claim 1, wherein the liquid crystal composition further comprises one or more compounds represented by Formula VII, 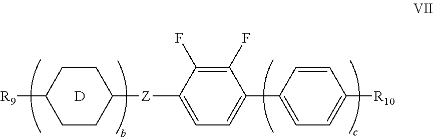
wherein
R₉ and R₁₀ each independently represent alkyl with a carbon atom number of 1-15, alkenyl with a carbon atom number of 2-15, or alkoxy with a carbon atom number of 1-15; and one or more non-adjacent —CH₂- in R₉ are optionally substituted with cyclopentylene or cyclopropylene;
Z represents a single bond, —CH₂ —CH₂-, —CH₂O-, or —CF₂O-;
b represents 1 or 2;
c represents 0 or 1; and 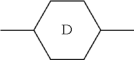
represents 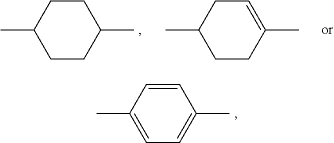
and when b represents 2, two 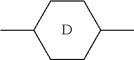
are optionally the same or different.

13. The liquid crystal composition according to claim 1, wherein the liquid crystal composition further comprises one or more compounds represented by Formula VIII, 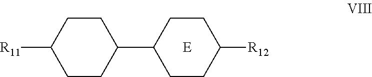
wherein
R₁₁ and R₁₂ each independently represent alkyl with a carbon atom number of 1-15, alkoxy with a carbon atom number of 1-15, or alkenyl with a carbon atom number of 2-15; 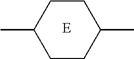
represents

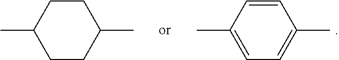

14. The liquid crystal composition according to claim 13, wherein the compound represented by Formula VIII is selected from the group consisting of compounds represented by the following Formulas VIII-1 to VIII-2, 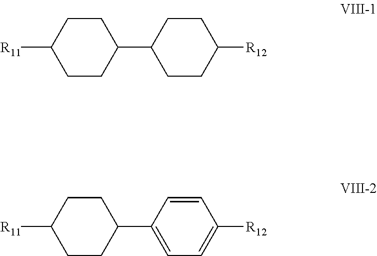
wherein
R₁₁ and R₁₂ each independently represent alkyl with a carbon atom number of 1-15, alkoxy with a carbon atom number of 1-15, or alkenyl with a carbon atom number of 2-15.

15. The liquid crystal composition according to claim 14, wherein the compound represented by Formula VIII-1 is selected from the group consisting of compounds represented by the following Formulas VIII-1-1 to VIII-1-7,

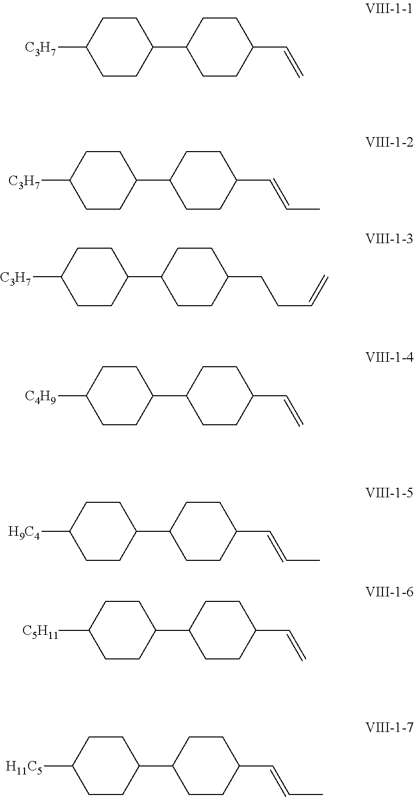

16. The liquid crystal composition according to claim 15, wherein the liquid crystal composition comprises one or more compounds represented by Formulas I-1 and I-2, one or more compounds represented by Formula II-1, one or more compounds represented by Formulas V-1-1 to V-1-17, and/or one or more compounds represented by Formulas V-2-2 and V-2-4, and necessarily comprises a compound represented by Formula VIII-1-1.

17. The liquid crystal composition according to claim 15, wherein the liquid crystal composition comprises one or more compounds represented by Formulas I-1 and I-2, one or more compounds represented by Formula II-1, one or more compounds represented by Formulas V-1-1 to V-1-13, and/or one or more compounds represented by Formulas V-2-2 and V-2-4, and necessarily comprises a compound represented by Formula VIII-1-1 and a compound represented by Formula VIII-1-2.

18. The liquid crystal composition according to claim 15, wherein the liquid crystal composition comprises one or more compounds represented by Formulas I-1 and I-2, one or more compounds represented by Formula II-1, one or more compounds represented by Formula IV-2, one or more compounds represented by Formulas V-1-1 to V-1-13, and/or one or more compounds represented by Formulas V-2-2 and V-2-4, and necessarily comprises a compound represented by Formula VIII-1-1 and a compound represented by Formula VIII-1-2.

19. The liquid crystal composition according to claim 15, wherein the liquid crystal composition comprises one or more compounds represented by Formula I-1 and I-2, one or more compounds represented by Formula II-1, one or more compounds represented by Formula IV-2, one or more compounds represented by Formulas V-1-1 to V-1-13 and/or one or more compounds represented by Formulas V-2-2 and V-2-4, and one or more compounds represented by Formulas VI-1 to VI-5, necessarily comprises a compound represented by Formula VIII-1-1 and a compound represented by Formula VIII-1-2.

20. A liquid crystal display element or liquid crystal display, characterized by comprising the liquid crystal composition according to claim 1, wherein the liquid crystal display element or liquid crystal display is an active matrix display element or display.
